(19) United States
(12) Patent Application Publication
(10) Pub. No.: US 2012/0244733 A1
(43) Pub. Date: Sep. 27, 2012

(54) COAXIAL CABLE CONNECTOR

(75) Inventors: Jeremy Amidon, Marcellus, NY (US); Brian K. Hanson, East Syracuse, NY (US); Noah Montena, Syracuse, NY (US); Eric Purdy, Constantia, NY (US)

(73) Assignee: John Mezzalingua Associates, Inc., East Syracuse, NY (US)

(21) Appl. No.: 13/072,605

(22) Filed: Mar. 25, 2011

(51) Int. Cl. H01R 9/05; H01R 13/52

(52) U.S. Cl. 439/271; 439/578

(57) ABSTRACT

A connector used in coaxial cable communication applications, and more specifically to coaxial connectors having features for sealing against environmental contaminants, facilitating effective attachment to a corresponding interface port, and improving the efficiency of structures and processes for attaching the connectors to coaxial cables. Furthermore, an associated method is also provided.

### FIELD OF TECHNOLOGY

The following relates to connectors used in coaxial cable communication applications, and more specifically to coaxial connectors having features for sealing against environmental contaminants, facilitating effective attachment to a corresponding interface port, and improving the efficiency of structures and processes for attaching the connectors to coaxial cables.

### BACKGROUND

Broadband communications have become an increasingly prevalent form of electromagnetic information exchange and coaxial cables are common conduits for transmission of broadband communications. Coaxial cables are typically designed so that an electromagnetic field carrying communications signals exists only in the space between inner and outer coaxial conductors of the cables. This allows coaxial cable runs to be installed next to metal objects without the power losses that occur in other transmission lines, and provides protection of the communications signals from external electromagnetic interference. Connectors for coaxial cables are typically connected onto complementary interface ports to electrically integrate coaxial cables to various electronic devices and cable communication equipment. Connection is often made through rotatable operation of an internally coupling member of the connector about a corresponding externally threaded interface port. Fully tightening the threaded connection of the coaxial cable connector to the interface port helps to ensure a ground connection between the connector and the corresponding interface port. However, often connectors are not properly tightened or otherwise installed to the interface port and proper electrical mating of the connector with the interface port does not occur. Moreover, when attached to an interface port, common connectors are often still susceptible to the unwanted introduction of environmental contaminants into the connector. In addition, common connectors often utilize cumbersome and/or costly components and installation processes associated with attaching the connectors to coaxial cables. Hence a need exists for an improved connector having structural features that facilitate efficient connection of the connector to an interface port, that help prevent the entry of unwanted environmental contaminants into the coaxial cable connector, and that improve cost and effectiveness with relation to how the connector attaches to a coaxial cable.

### SUMMARY

A first aspect of the present invention relates to a coaxial cable connector comprising a connector body; a post, engageable with the connector body; a coupling member, axially rotatable with respect to the connector body, the coupling member having a first end and opposing second end; an outer sleeve engageable with the coupling member, the sleeve configured to rotate the coupling member; and a compression portion structurally integral with the connector body, wherein the compression portion is configured to break apart from the body when axially compressed.

A second aspect of the present invention relates to a coaxial cable connector comprising; a connector body; a post engageable with connector body; a coupling member, axially rotatable with respect to the connector body, the coupling member having a first end and opposing second end portion; a sealing element attached to the coupling member, wherein the sealing element prevents ingress of environmental elements proximate the first end of the coupling member; and an outer sleeve engageable with the coupling member, the sleeve configured to rotate the coupling member.

A third aspect of the present invention relates to a coaxial cable connector comprising: a connector body; a post engageable with connector body; a coupling member, axially rotatable with respect to the connector body, the coupling member having a first end and opposing second end; a sealing element attached to the coupling member, wherein the sealing element prevents ingress of environmental elements proximate the first end of the coupling member; and a compression portion structurally integral with the connector body, wherein the compression portion is configured to break apart from the body when axially compressed.

A fourth aspect of the present invention relates to a method of fastening a coaxial cable to a communication port, the method comprising: providing a coaxial cable connector including: a connector body; a post operably attached to the connector body; a coupling member axially rotatable with respect to the connector body; an outer sleeve engageable with the coupling member; and a compression portion structurally integral with the connector body; axially compressing the compression portion to form an environmental seal around the coaxial cable, wherein when axially compressed, the compression portion breaks away from the body and securely connects to the coaxial cable; and fastening the coupling member to an interface port by operating the outer sleeve.

The foregoing and other features of construction and operation of the invention will be more readily understood and fully appreciated from the following detailed disclosure, taken in conjunction with accompanying drawings.

### BRIEF DESCRIPTION OF THE DRAWINGS

Some of the embodiments will be described in detail, with reference to the following figures, wherein like designations denote like members, wherein:

FIG. 1A depicts a cross-section view of a first embodiment of a coaxial cable connector including an embodiment of an outer sleeve, an embodiment of a compression portion, and an embodiment of a radial restriction member;

FIG. 1B depicts a perspective view of the first embodiment of the coaxial cable connector prior to an embodiment of the sleeve is operably attached to an embodiment of a coupling member;

FIG. 1C depicts a cross-section view of the first embodiment of the coaxial cable connector after secure attachment to an embodiment of a coaxial cable;

FIG. 2 depicts a cross-section view of a second embodiment of a coaxial cable connector including an embodiment of an outer sleeve, an embodiment of a compression portion, and an embodiment of a radial restriction member;

FIG. 3 depicts a cross-section view of a third embodiment of a coaxial cable connector including an embodiment of an outer sleeve, an embodiment of a compression portion, and an embodiment of a radial restriction member;

FIG. 4A depicts a cross-section view of a fourth embodiment of a coaxial cable connector including an embodiment of an outer sleeve, an embodiment of a compression portion, and an embodiment of a radial restriction member;

FIG. 4B depicts a perspective view of the fourth embodiment of the coaxial cable connector prior to an embodiment of a sleeve is operably attached to an embodiment of a coupling member;

FIG. 5 depicts a cross-section view of a fifth embodiment of a coaxial cable connector including an embodiment of an outer sleeve, an embodiment of a compression portion, and an embodiment of a radial restriction member;

FIG. 6 depicts a cross-section view of a sixth embodiment of a coaxial cable connector including an embodiment of an outer sleeve, an embodiment of a compression portion, and an embodiment of a radial restriction member;

FIG. 7 depicts a cross-section view of an seventh embodiment of a coaxial cable connector including an embodiment of an outer integral sleeve, an embodiment of a compression portion, and an embodiment of a radial restriction member;

FIG. 8 depicts a cross-section view of an eighth embodiment of a coaxial cable connector including an embodiment of an outer integral sleeve, an embodiment of a compression portion, and an embodiment of a radial restriction member;

FIG. 9 depicts a cross-section view of a ninth embodiment of a coaxial cable connector including an embodiment of an outer integral sleeve, an embodiment of a compression portion, and an embodiment of a radial restriction member;

FIG. 10 depicts a cross-section view of a tenth embodiment of a coaxial cable connector including an embodiment of a sealing member, an embodiment of an outer sleeve, an embodiment of a compression portion, and an embodiment of a radial restriction member;

FIG. 11 depicts a cross-section view of an eleventh embodiment of a coaxial cable connector including an embodiment of a sealing member, an embodiment of an outer sleeve, an embodiment of a compression portion, and an embodiment of a radial restriction member;

FIG. 12 depicts a cross-section view of a twelfth embodiment of a coaxial cable connector including an embodiment of an outer sleeve, an embodiment of a sealing member, an embodiment of a compression portion, and an embodiment of a radial restriction member;

FIG. 13 depicts a cross-section view of a thirteenth embodiment of a coaxial cable connector including an embodiment of an outer sleeve, an embodiment of a compression portion, and an embodiment of a radial restriction member;

FIG. 14 depicts a cross-section view of a fourteenth embodiment of a coaxial cable connector including an embodiment of an outer sleeve, an embodiment of a compression portion, and an embodiment of a radial restriction member;

FIG. 15 depicts a cross-section view of a fifteenth embodiment of a coaxial cable connector including an embodiment of an outer sleeve, an embodiment of a compression portion, and an embodiment of a radial restriction member;

FIG. 16 depicts a cross-section view of a sixteenth embodiment of a coaxial cable connector including an embodiment of an outer sleeve, an embodiment of a compression portion, and an embodiment of a radial restriction member;

FIG. 17 depicts a cross-section view of a seventeenth embodiment of a coaxial cable connector including an embodiment of an outer sleeve, an embodiment of a compression portion, and an embodiment of a radial restriction member;

FIG. 18 depicts a cross-section view of an eighteenth embodiment of a coaxial cable connector including an embodiment of an outer sleeve, an embodiment of a compression portion, and an embodiment of a radial restriction member;

FIG. 19 depicts a cross-section view of a nineteenth embodiment of a coaxial cable connector including an embodiment of an outer sleeve, an embodiment of a compression portion, and an embodiment of a radial restriction member;

FIG. 20 depicts a cross-section view of a twentieth embodiment of a coaxial cable connector including an embodiment of an outer sleeve, an embodiment of a compression portion, and an embodiment of a radial restriction member;

FIG. 21 depicts a cross-section view of a twenty-first embodiment of a coaxial cable connector including an embodiment of an outer sleeve, an embodiment of a compression portion, and an embodiment of a radial restriction member;

FIG. 22 depicts a cross-section view of a twenty-second embodiment of a coaxial cable connector including an embodiment of an outer sleeve, an embodiment of an outer sleeve, an embodiment of a compression portion, and an embodiment of a radial restriction member; and

FIG. 23 depicts a cross-section view of a twenty-third embodiment of a coaxial cable connector including an embodiment of an outer sleeve, an embodiment of an outer sleeve, and an embodiment of a compression portion, and an embodiment of a radial restriction member;

FIG. 24 depicts a cross-section view of a twenty-fourth embodiment of a coaxial cable connector including an embodiment of an outer sleeve, an embodiment of an outer sleeve, an embodiment of a compression portion, and an embodiment of a radial restriction member;

FIG. 25 depicts a cross-section view of a twenty-fifth embodiment of a coaxial cable connector including an embodiment of a sealing member, an embodiment of a compression portion, and an embodiment of a radial restriction member;

FIG. 26 depicts a cross-section view of a twenty-sixth embodiment of a coaxial cable connector including an embodiment of a sealing member, an embodiment of a compression portion, and an embodiment of a radial restriction member;

FIG. 27 depicts a cross-section view of a twenty-seventh embodiment of a coaxial cable connector including an embodiment of a sealing member, an embodiment of a compression portion, and an embodiment of a radial restriction member;

FIG. 28 depicts a cross-section view of a twenty-eighth embodiment of a coaxial cable connector including an embodiment of a sealing member, an embodiment of an outer sleeve, an embodiment of a compression portion configured to move axially external to an embodiment of a connector body; and

FIG. 29 depicts a cross-section view of a twenty-ninth embodiment of a coaxial cable connector including an embodiment of a sealing member, an embodiment of an outer sleeve, and an embodiment of a compression portion configured to move axially within an embodiment of a connector body.

### DETAILED DESCRIPTION

Although certain embodiments of the present invention are shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of embodiments of the present invention.

As a preface to the detailed description, it should be noted that, as used in this specification and the appended claims, the singular forms “a”, “an” and “the” include plural referents, unless the context clearly dictates otherwise.

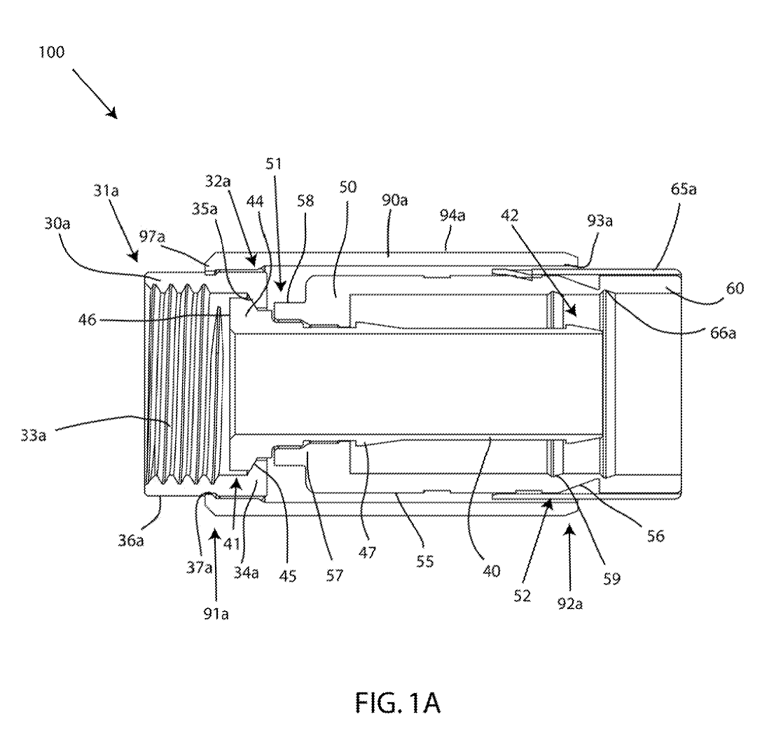

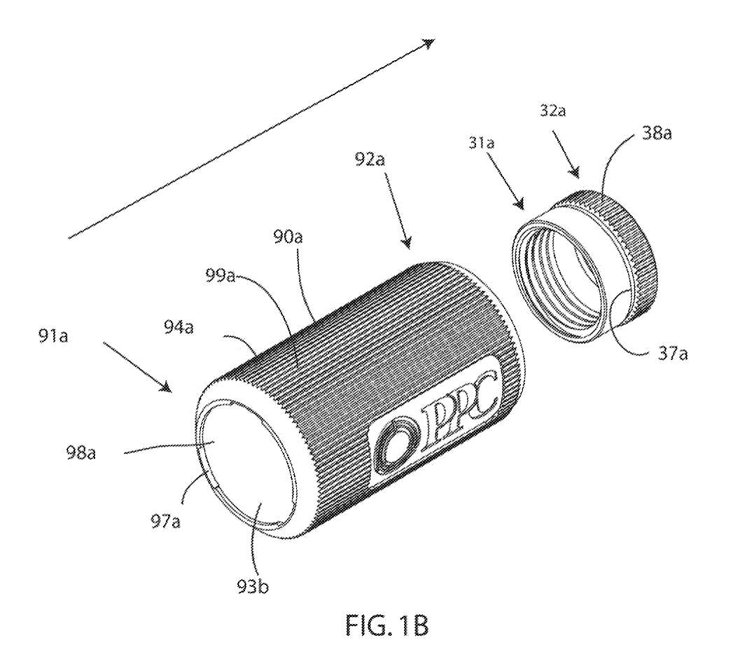

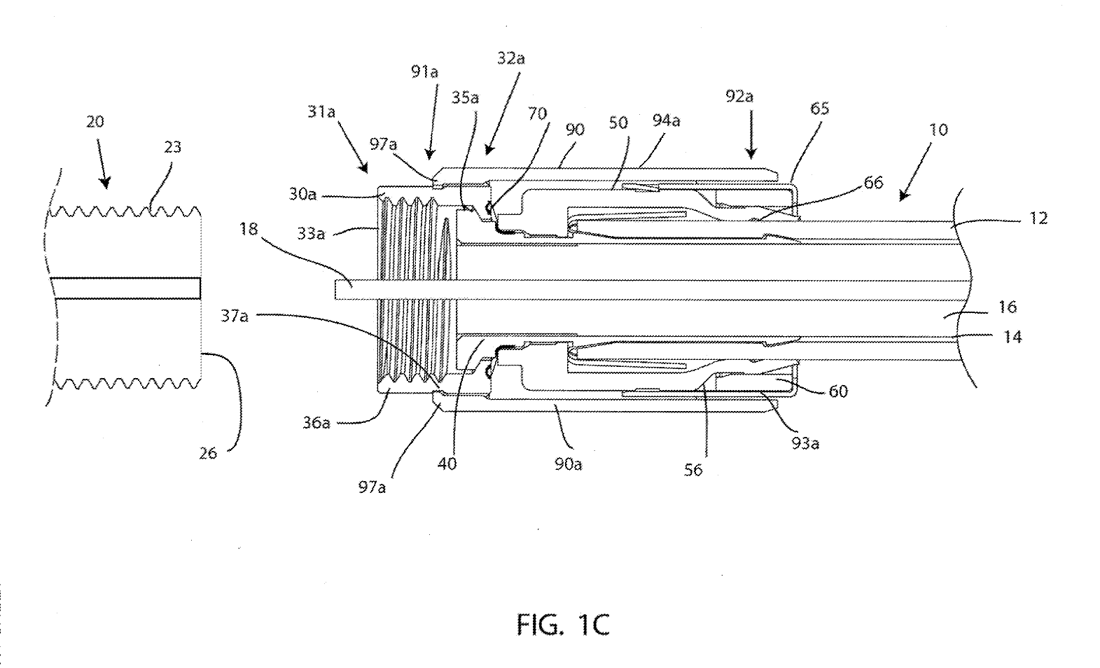

Referring to the drawings, FIGS. 1A-29 depict embodiments of a coaxial cable connector 100-128. The coaxial cable connector 100-128 may be operably affixed, or otherwise functionally attached, to a coaxial cable 10 having a protective outer jacket 12, a conductive grounding shield 14, an interior dielectric 16 and a center conductor 18 (the cable 10 being shown in FIG. 1C). The coaxial cable 10 may be prepared as embodied in FIG. 1C by removing the protective outer jacket 12 and drawing back the conductive grounding shield 14 to expose a portion of the interior dielectric 16. Further preparation of the embodied coaxial cable 10 may include stripping the dielectric 16 to expose a portion of the center conductor 18. The protective outer jacket 12 is intended to protect the various components of the coaxial cable 10 from damage which may result from exposure to dirt or moisture and from corrosion. Moreover, the protective outer jacket 12 may serve in some measure to secure the various components of the coaxial cable 10 in a contained cable design that protects the cable 10 from damage related to movement during cable installation. The conductive grounding shield 14 may be comprised of conductive materials suitable for providing an electrical ground connection, such as cuprous braided material, aluminum foils, thin metallic elements, or other like structures. Various embodiments of the shield 14 may be employed to screen unwanted noise. For instance, the shield 14 may comprise a metal foil wrapped around the dielectric 16, or several conductive strands formed in a continuous braid around the dielectric 16. Combinations of foil and/or braided strands may be utilized wherein the conductive shield 14 may comprise a foil layer, then a braided layer, and then a foil layer. Those in the art will appreciate that various layer combinations may be implemented in order for the conductive grounding shield 14 to effectuate an electromagnetic buffer helping to prevent ingress of environmental noise that may disrupt broadband communications. The dielectric 16 may be comprised of materials suitable for electrical insulation, such as plastic foam material, paper materials, rubber-like polymers, or other functional insulating materials. It should be noted that the various materials of which all the various components of the coaxial cable 10 are comprised should have some degree of elasticity allowing the cable 10 to flex or bend in accordance with traditional broadband communication standards, installation methods and/or equipment. It should further be recognized that the radial thickness of the coaxial cable 10, protective outer jacket 12, conductive grounding shield 14, interior dielectric 16 and/or center conductor 18 may vary based upon generally recognized parameters corresponding to broadband communication standards and/or equipment.

Referring further to FIGS. 1A-29, a connector, such as connector 100-128 may also interact with a coaxial cable interface port 20. The coaxial cable interface port 20 includes a conductive receptacle for receiving a portion of a coaxial cable center conductor 18 sufficient to make adequate electrical contact. The coaxial cable interface port 20 may further comprise a threaded exterior surface 23. It should be recognized that the radial thickness and/or the length of the coaxial cable interface port 20 and/or the conductive receptacle of the port 20 may vary based upon generally recognized parameters corresponding to broadband communication standards and/or equipment. Moreover, the pitch and height of threads which may be formed upon the threaded exterior surface 23 of the coaxial cable interface port 20 may also vary based upon generally recognized parameters corresponding to broadband communication standards and/or equipment. Furthermore, it should be noted that the interface port 20 may be formed of a single conductive material, multiple conductive materials, or may be configured with both conductive and non-conductive materials corresponding to the port's 20 operable electrical interface with a connector 100-128. However, the receptacle of the port 20 should be formed of a conductive material, such as a metal, like brass, copper, or aluminum. Further still, it will be understood by those of ordinary skill that the interface port 20 may be embodied by a connective interface component of a coaxial cable communications device, a television, a modem, a computer port, a network receiver, or other communications modifying devices such as a signal splitter, a cable line extender, a cable network module and/or the like.

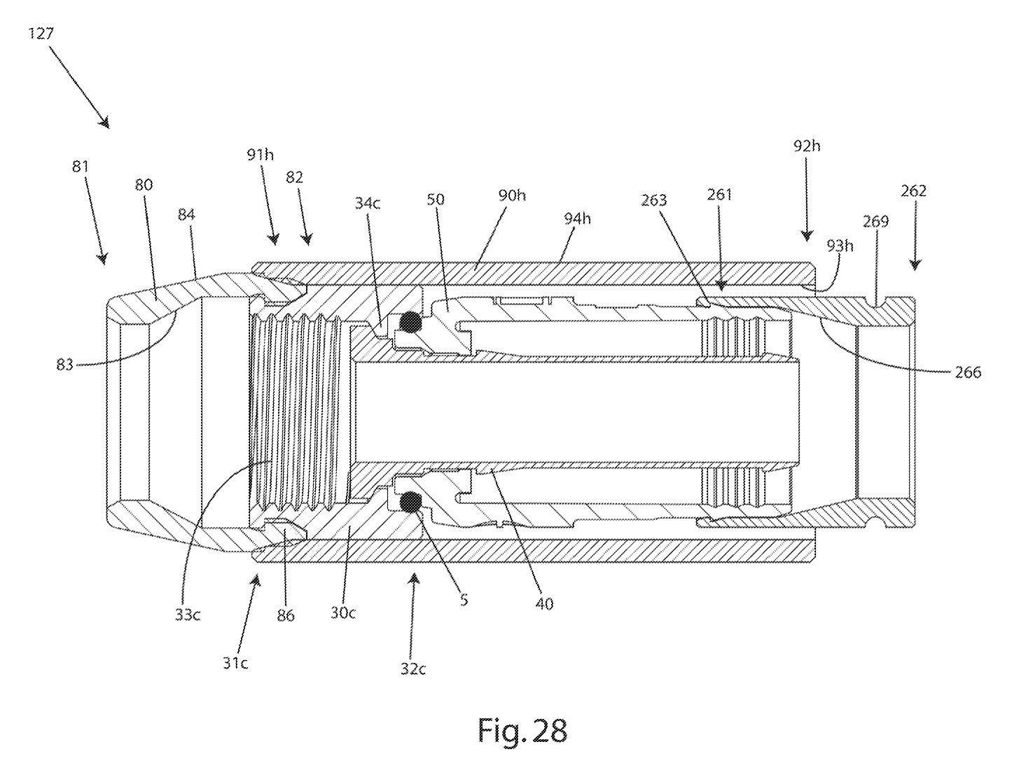

Referring now to FIGS. 1A-25, embodiments of a coaxial cable connector 100-123 may further comprise a coupling member 30, a post 40, a connector body 50, an outer sleeve 90, a compression portion 60, a radial restriction member 65, and a connector body seal member 5 (as shown in FIG. 28), such as, for example, a body O-ring configured to fit around a portion of the connector body 50. Embodiments of coupling member 30 may be coupling member 30a, 30b, or 30c described in further detail infra. Embodiments of sleeve 90 may be sleeve 90a, 90b, 90c, 90d, 90e, 90f, 90g, or 90h, described in further detail infra. Similarly, embodiments of radial restriction member 65 may be 65a, 65b, or 65c, described in further detail infra. Connector 100-123 may come in a preassembled configuration or may require additional operable attachment of the sleeve 90 to connector 100-123 during installation.

Referring now to FIG. 1A, embodiments of connector 100 may include a coupling member 30a, a post 40, a connector body 50, an outer sleeve 90a, a compression portion 60, and a radial restriction member 65a.

Embodiments of connector 100 may include a coupling member 30a. The coupling member 30a of embodiments of a coaxial cable connector 100 has a first forward end 31a and opposing second rearward end 32a. The coupling member 30a may comprise internal threading 33a extending axially from the edge of first forward end 31a a distance sufficient to provide operably effective threadable contact with the external threads 23 of a standard coaxial cable interface port 20 (as shown, by way of example, in FIG. 1C). The coupling member 30a includes an internal lip 34a, such as an annular protrusion, located proximate the second rearward end 32a of the coupling member. The internal lip 34a includes a surface 35a facing the first forward end 31a of the coupling member 30a. The forward facing surface 35a of the lip 34a may be a tapered surface or side facing the first forward end 31a of the coupling member 30a. However, the internal lip 34a of coupling member 30a may define the second end 32a of the coupling member 30a, eliminating excess material from the coupling member 30a. Located somewhere on the outer surface 36a of the coupling member 30a may be a retaining structure 37a. The retaining structure 37a of the coupling member 30a may be an annular groove or recess that extends completely or partially around the outer surface 36a of the coupling member 30a to retain, accommodate, receive, or mate with an engagement member 97 of the sleeve 90. Alternatively, the retaining structure 37a may be an annular protrusion that extends completely or partially around the outer surface 36a of the coupling member 30a to retain or mate with the engagement member 97 of the outer sleeve 90. The retaining structure 37a may be placed at various axial positions from the first end 31a to the 32a, depending on the configuration of the sleeve 90 and other design requirements of connector 100.

Moreover, embodiments of coupling member 30a may include an outer surface feature(s) 38a proximate or otherwise near the second end 32a to improve mechanical interference or friction between the coupling member 30a and the sleeve 90. For instance, the outer surface feature 38a may extend completely or partially around the outer surface 36a proximate the second 32a of the coupling member 30a to increase a retention force between an inner surface 93 of the sleeve 90 and the outer surface 36a of the coupling member 30a. The outer surface feature 38a may include a knurled surface, a slotted surface, a plurality of bumps, ridges, grooves, or any surface feature that may facilitate contact between the sleeve 90 and the coupling member 30a. In one embodiment, the coupling member 30a may be referred to as a press-fit coupling member.

The structural configuration of the coupling member 30a may vary according differing connector design parameters to accommodate different functionality of a coaxial cable connector 100. For instance, the first forward end 31a of the coupling member 30a may include internal and/or external structures such as ridges, grooves, curves, detents, slots, openings, chamfers, or other structural features, etc., which may facilitate the operable joining of an environmental sealing member, such a water-tight seal or other attachable component element, that may help prevent ingress of environmental contaminants, such as moisture, oils, and dirt, at the first forward end 31a of the coupling member 30a, when mated with an interface port 20. Those in the art should appreciate that the coupling member 30a need not be threaded. Moreover, the coupling member 30a may comprise a coupler commonly used in connecting RCA-type, or BNC-type connectors, or other common coaxial cable connectors having standard coupler interfaces. The coupling member 30a may be formed of conductive materials, such as copper, brass, aluminum, or other metals or metal alloys, facilitating grounding through the coupling member 30a. Further embodiments of the coupling member 30a may be formed of polymeric materials and may be non-conductive. Accordingly, the coupling member 30a may be configured to extend an electromagnetic buffer by electrically contacting conductive surfaces of an interface port 20 when a connector 100 is advanced onto the port 20. In addition, the coupling member 30a may be formed of both conductive and non-conductive materials. For example the external surface of the coupling member 30a may be formed of a polymer, while the remainder of the coupling member 30a may be comprised of a metal or other conductive material. The coupling member 30a may be formed of metals or polymers or other materials that would facilitate a rigidly formed coupling member body. Manufacture of the coupling member 30a may include casting, extruding, cutting, knurling, turning, tapping, drilling, injection molding, blow molding, combinations thereof, or other fabrication methods that may provide efficient production of the component. The forward facing surface 35a of the coupling member 30a faces a flange 44 the post 40 when operably assembled in a connector 100, so as to allow the coupling member 30a to rotate with respect to the other component elements, such as the post 40 and the connector body 50, of the connector 100.

Embodiments of connector 100 may include a post 40. The post 40 comprises a first forward end 41 and an opposing second rearward end 42. Furthermore, the post 40 may comprise a flange 44, such as an externally extending annular protrusion, located at the first end 41 of the post 40. The flange 44 includes a rearward facing surface 45 that faces the forward facing surface 35a, 35b, 35c of the coupling member 30a, 30b, 30c when operably assembled in a coaxial cable connector, so as to allow the coupling member 30 to rotate with respect to the other component elements, such as the post 40 and the connector body 50, of the connector 100-128. The rearward facing surface 45 of flange 44 may be a tapered surface facing the second rearward end 42 of the post 40. Further still, an embodiment of the post 40 may include a surface feature 47 such as a lip or protrusion that may engage a portion of a connector body 50 to secure axial movement of the post 40 relative to the connector body 50. However, the post need not include such a surface feature 47, and the coaxial cable connector 100-128 may rely on press-fitting and friction-fitting forces and/or other component structures having features and geometries to help retain the post 40 in secure location both axially and rotationally relative to the connector body 50. The location proximate or near where the connector body is secured relative to the post 40 may include surface features 43, such as ridges, grooves, protrusions, or knurling, which may enhance the secure attachment and locating of the post 40 with respect to the connector body 50. Moreover, various components having larger or smaller diameters can be readily press-fit or otherwise secured into connection with each other. Additionally, the post 40 may include a mating edge 46, which may be configured to make physical and electrical contact with a corresponding mating edge 26 of an interface port 20 (as shown in exemplary fashion in FIG. 1C) The post 40 should be formed such that portions of a prepared coaxial cable 10 including the dielectric 16 and center conductor 18 (examples shown in FIG. 1C) may pass axially into the second end 42 and/or through a portion of the tube-like body of the post 40. Moreover, the post 40 should be dimensioned, or otherwise sized, such that the post 40 may be inserted into an end of the prepared coaxial cable 10, around the dielectric 16 and under the protective outer jacket 12 and conductive grounding shield 14. Accordingly, where an embodiment of the post 40 may be inserted into an end of the prepared coaxial cable 10 under the drawn back conductive grounding shield 14, substantial physical and/or electrical contact with the shield 14 may be accomplished thereby facilitating grounding through the post 40. The post 40 should be conductive and may be formed of metals or may be formed of other conductive materials that would facilitate a rigidly formed post body. In addition, the post may be formed of a combination of both conductive and non-conductive materials. For example, a metal coating or layer may be applied to a polymer of other non-conductive material. Manufacture of the post 40 may include casting, extruding, cutting, turning, drilling, knurling, injection molding, spraying, blow molding, component overmolding, combinations thereof, or other fabrication methods that may provide efficient production of the component.

Embodiments of a coaxial cable connector, such as connector 100, may include a connector body 50. The connector body 50 may comprise a first end 51 and opposing second end 52. Moreover, the connector body may include a post mounting portion 57 proximate or otherwise near the first end 51 of the body 50, the post mounting portion 57 configured to securely locate the body 50 relative to a portion of the outer surface of post 40, so that the connector body 50 is axially secured with respect to the post 40, in a manner that prevents the two components from moving with respect to each other in a direction parallel to the axis of the connector 100. The internal surface of the post mounting portion 57 may include an engagement feature, such as an annular detent or ridge having a different diameter than the rest of the post mounting portion 57. However other features such as grooves, ridges, protrusions, slots, holes, keyways, bumps, nubs, dimples, crests, rims, or other like structural features may be included. In addition, the connector body 50 may include an outer annular recess 58 located proximate or near the first end 51 of the connector body 50. Furthermore, the connector body 50 may include a semi-rigid, yet compliant outer surface 55, wherein the outer surface 55 may be configured to form an annular seal when the second end 52 is deformably compressed against a received coaxial cable 10 by operation of a compression portion 60. The connector body 50 may include an outer ramped surface 56 and an internal annular notch 59 or groove proximate the second end 52 to structurally facilitate the deformation of the connector body 50, as described in further detail infra.

Moreover, the connector body 50 may include an external annular detent located proximate or close to the second end 52 of the connector body 50. Further still, the connector body 50 may include internal surface features, such as annular serrations formed near or proximate the internal surface of the second end 52 of the connector body 50 and configured to enhance frictional restraint and gripping of an inserted and received coaxial cable 10, through tooth-like interaction with the cable. The connector body 50 may be formed of materials such as plastics, polymers, bendable metals or composite materials that facilitate a semi-rigid, yet compliant outer surface 55. Further, the connector body 50 may be formed of conductive or non-conductive materials or a combination thereof. Manufacture of the connector body 50 may include casting, extruding, cutting, turning, drilling, knurling, injection molding, spraying, blow molding, component overmolding, combinations thereof, or other fabrication methods that may provide efficient production of the component.

With continued reference to FIG. 1A, embodiments of connector 100 may include a sleeve 90a. The sleeve 90a may be engageable with the coupling member 30a. The sleeve 90a may include a first end 91a, a second 91a, an inner surface 93a, and an outer surface 94a. The sleeve 90a may be a generally annular member having a generally axial opening therethrough. The sleeve 90a may be radially disposed over the coupling member 30a, or a portion thereof, the connector body 50, or a portion thereof the compression portion 60, or a portion thereof, and radial restriction member 65, or a portion thereof, while operably assembled and/or in a compressed position. Proximate or otherwise near the first end 91a, the sleeve 90a may include an engagement member 97a configured to mate or engage with the retaining structure 37a of the coupling member 30a. The engagement member 97a may be an annular lip or protrusion that may enter or reside within the retaining structure 37a of the coupling member 30a. For example, in embodiments where the retaining structure 37a is an annular groove, the engagement member 97a may be a protrusion or lip that may snap into the groove located on the coupling member 30a to retain the sleeve 90a in a single axial position. In other words, the cooperating surfaces of the groove-like retaining structure 37a and the lip or protruding engagement member 97a may prevent axial movement of the sleeve 90a once the connector 100 is in an assembled configuration. Alternatively, the engagement member 97a may be an annular groove or recess that may receive or engage with the retaining structure 37a of the coupling member 30a. For example, in embodiments where the retaining structure 37a of the coupling member 30a is an annular protrusion, the engagement member 97a may be a groove or recess that may allow the annular protruding retaining structure 37a of the coupling member 30a to snap into to retain the sleeve 90a in a single axial position. In other words, the cooperating surfaces of the protruding retaining structure 37a and the groove-like engagement member 97a may prevent axial movement of the sleeve 90a once the connector 100 is in an assembled configuration. Those having skill in the art should understand that various surface features effectuating cooperating surfaces between the coupling member 30 and the sleeve 90 may be implemented to retain the sleeve 90a with respect to the rest of the connector 100 in an axial direction. Furthermore, the engagement member 97a of the sleeve 90a may be segmented such that one or more gaps may separate portions of the engagement member 97a, while still providing sufficient structural engagement with the retaining structure 37a.

An embodiment of an assembled configuration of connector 100 with respect to the sleeve 90a may involve sliding the sleeve 90a over the coupling member 30a in an axial direction starting from the first end 31a and continuing toward the second end 32a of the coupling member 30a until sufficient mating and/or engagement occurs between the engagement member 97a of the sleeve 90a and the retaining structure 37a of the coupling member 30a, as shown in FIG. 1B. Once in the assembled configuration, rotation of the sleeve 90a may in turn cause the coupling member 30a to simultaneously rotate in the same direction as the sleeve 90a due to mechanical interference between the inner surface 93a of the sleeve 90a and the outer surface 36a of the coupling member 30a. In some embodiments, the interference between the sleeve 90a and the coupling member 30a relies simply on a friction fit or interference fit between the components. Other embodiments include a coupling member 30a with an outer surface feature(s) 38a, as described supra, to improve the mechanical interference between the components. Further embodiments include a sleeve 90a with internal surface features 98a positioned on the inner surface 93a to improve the contact between the components. Even further embodiments of connector 100 may include a sleeve 90a and a coupling member 30a both having surface features 98a, 38a, respectively. Embodiments of the inner surface features 98a of the sleeve 90a may include a knurled surface, a slotted surface, a plurality of bumps, ridges, rib, grooves, or any surface feature that may facilitate contact between the sleeve 90a and the coupling member 30. In many embodiments, the inner surface features 98a of the sleeve 90a and the outer surface features 38a of the coupling member 30a may structurally correspond with each other. For example, the inner geometry of the sleeve 90a may reflect and/or structurally correspond with the outer geometric shape of the coupling member 30a. Due to the engagement between the sleeve 90a and the coupling member 30a, a user may simply grip and rotate/twist the sleeve 90a to thread the coupling element 30a onto an interface port, such as interface port 20. Further still, embodiments of the sleeve 90a may include outer surface features 99a, such as annular serrations or slots, configured to enhance gripping of the sleeve 90a while connecting the connector 100 onto an interface port. The sleeve 90a may be formed of materials such as plastics, polymers, bendable metals or composite materials that facilitate a rigid body. Further, the sleeve 90a may be formed of conductive or non-conductive materials or a combination thereof. Manufacture of the sleeve 90a may include casting, extruding, cutting, turning, drilling, knurling, injection molding, spraying, blow molding, component overmolding, combinations thereof, or other fabrication methods that may provide efficient production of the component.

Embodiments of connector 100 may include a compression portion 60. Compression portion 60 may be operably attached to the connector body 50. For instance, the compression portion 60 may be structurally integral with the connector body 50, wherein the compression portion 60 separates or shears from the connector body 50 upon an axial force which in turn radially compresses the second end 52 of the connector body 50 onto the coaxial cable 10, as shown in FIG. 1C. The structural connection between the connector body 50 and the compression portion 60 may be thin or otherwise breakable when compressive, axial force is applied (e.g. by an axial compression tool). For example, the compression portion 60 may have a frangible connection with the connector body 50. Moreover, the structural connection or configuration between the connector body 50 and the compression portion 60 may be defined by an internal annular notch 66 or groove of the compression portion 60 and an outer ramped surface 56 of the connector body 50. The annular notch 59 of the connector body 50 may further facilitate the deformation of the second end 52 of the connector body 1350. The compression portion 60 may be formed of the same material as connector body 50 because they may be structurally integral with each other. For example, the compression portion 60 may be comprised of materials such as plastics, polymers, bendable metals or composite materials that facilitate a rigid body. Further, the compression portion 60 may be formed of conductive or non-conductive materials or a combination thereof. Manufacture of the compression member 60 may include casting, extruding, cutting, turning, drilling, knurling, injection molding, spraying, blow molding, component overmolding, combinations thereof, or other fabrication methods that may provide efficient production of the component.

Furthermore, embodiments of connector 100 may include a radial restriction member 65a. The radial restriction member 65a may be a bushing or similar annular tubular member disposed proximate the rearward second end 52 of the connector body 50. For instance, the radial restriction member 65a may surround the compression portion 60 and a portion of the connector body 50 proximate the rearward second end 52. The radial restriction member 65a may be a generally annular, hollow cylindrically-shaped sleeve-like member comprised of stainless steel or other substantially rigid materials which may structurally assist the crack and seal process of compression portion 60. For instance, when the compression portion 60 is axially compressed in a direction towards the coupling member 30, the radial restriction member 65a may axially displace along with the compression portion 60 and may prevent the compression portion 60 from splintering or otherwise displacing in a direction other than substantially axial towards the coupling member 30.

Embodiments of the compression portion 60 may create an environmental seal around the coaxial cable 10 when in the fully compressed position. Specifically, when the compression portion 60 (and the radial restriction member 65a) is axially slid or compressed towards the coupling member 30, the structural connection between the compression portion 60 and the connector body 50 is severed, sheared, ruptured, etc., and the compression portion 60 comes into contact with the outer ramped surface 56 of the connector body 50. The severing of the structural connection between the connector body 50 and the compression portion 60 essentially turns the internal notch 66a into a cooperative ramped surface with the outer ramped surface 56 of the connector body 50. Due to the cooperative ramped surfaces, the axial compression (displacement) of the compression portion 60 evenly compresses the second end 52 of the connector body 50 onto the outer jacket 12 of the coaxial cable 10 and deforms the outer ramped surface 56, as shown in FIG. 1C. Accordingly, the compression portion 60 and potentially the radial restriction member 65a may be referred to as a crack and seal compression means with a radial restriction member 65a. Those skilled in the requisite art should appreciate that the seal may be created by the compression portion 60 without the radial restriction member 65a. However, the radial restriction member 65a significantly enhances the structural integrity and functional operability of the compression portion, for example, when it is compressed and sealed against an attached coaxial cable 10.

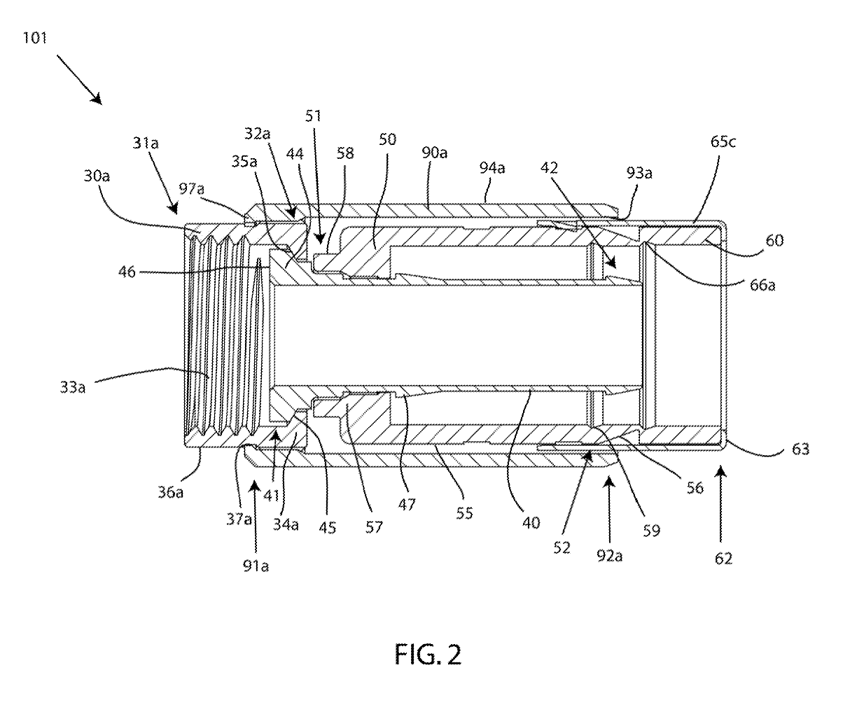

With reference to FIG. 2, embodiments of connector 101 may include a coupling member 30a, a post 40, a connector body 50, an outer sleeve 90a, a compression portion 60, and a radial restriction member 65c. Radial restriction member 65c may share the same or substantially the same function as radial restriction member 65a. However, radial restriction member 65c may be a cap member, or similar generally annular, tubular member having an engagement surface for operable engagement with a compression tool. For instance, embodiments of the radial restriction member 65c may include an internal annular lip 63 or inwardly extending flange proximate a rearward end 62 of the radial restriction member 65c. The radial restriction member 65c may surround or partially surround the compression portion 60 and a portion of the connector body 50 proximate the rearward second end 52, wherein the internal annular lip 63 of the radial restriction member 65c may be configured to contact the compression portion 6a prior to or upon axial compression of the connector. The radial restriction member 65c may be comprised of stainless steel or other substantially rigid materials which may structurally assist the crack and seal process of compression portion 60. For instance, when the compression portion 60 is axially compressed in a direction towards the coupling member 30, the radial restriction member 65c may axially displace along with the compression portion 60 and may prevent the compression portion 60 from splintering or otherwise displacing in a direction other than substantially axial towards the coupling member 30. Additionally, the internal lip 63 proximate the rearward end 62 of the radial restriction member 65c may provide an engagement surface for operable engagement with a compression tool, or other device/means that provides the necessary compression to compress seal connector 1302.

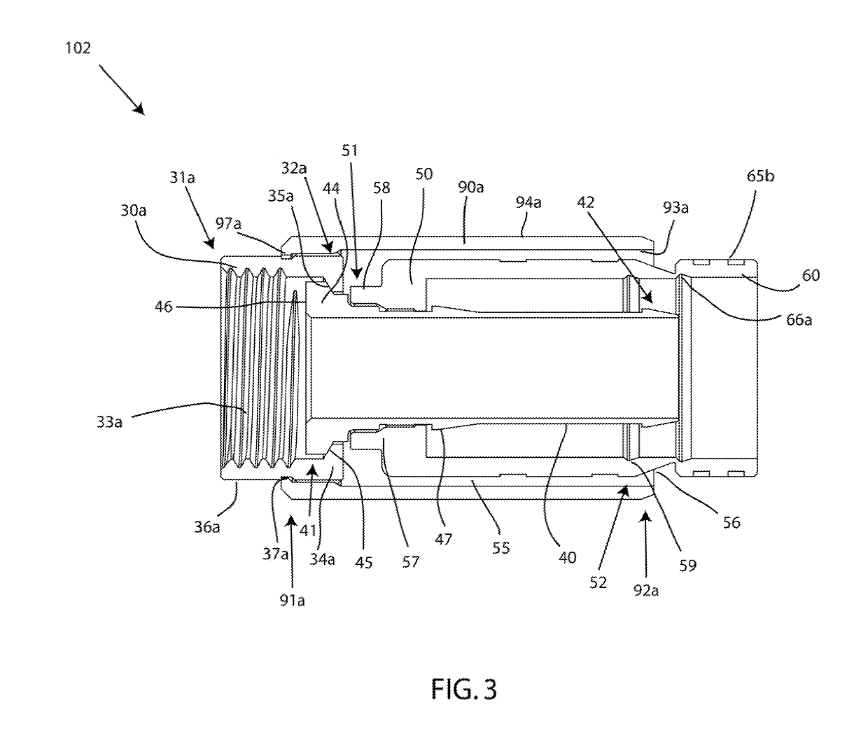

Referring now to FIG. 3, embodiments of connector 102 may include a coupling member 30a, a post 40, a connector body 50, an outer sleeve 90a, a compression portion 60, and a radial restriction member 65b. Radial restriction member 65b may share the same or substantially the same function as radial restriction member 65a. However, radial restriction member 65b may be one or more straps or bands that extend annularly around or partially around the compression portion 60. The radial restriction member 65b may be structurally attached to the compression portion 60 in a variety of methods, such as press-fit, adhesion, cohesion, fastened, etc. For instance, the radial restriction member 65b may reside within annular notches or grooves in the compression portion 60. The notches or grooves may have various depths to allow the radial restriction member 65 to be flush with the outer surface of the compression portion 60, to protrude from the outer surface of the compression portion 60, or to reside completely beneath the outer surface of the compression portion 60. Moreover, the radial restriction member 65 may be comprised of stainless steel or other substantially rigid materials which may structurally assist the crack and seal process of compression portion 60. For instance, when the compression portion 60 is axially compressed in a direction towards the coupling member 30a, the radial restriction member 65b may also prevent the compression portion 60 from splintering or otherwise displacing in a direction other than substantially axial towards the coupling member 30a.

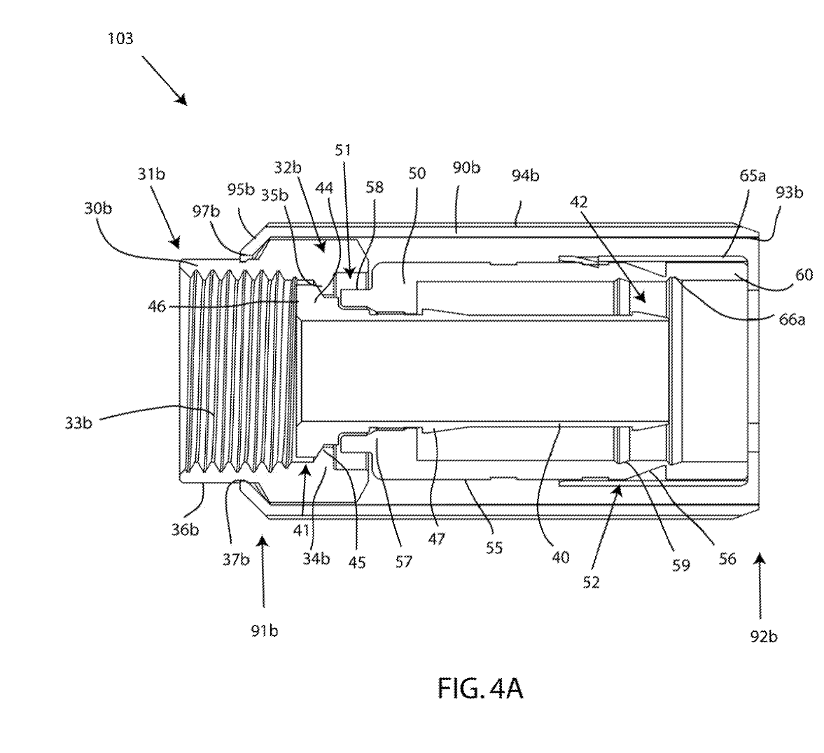

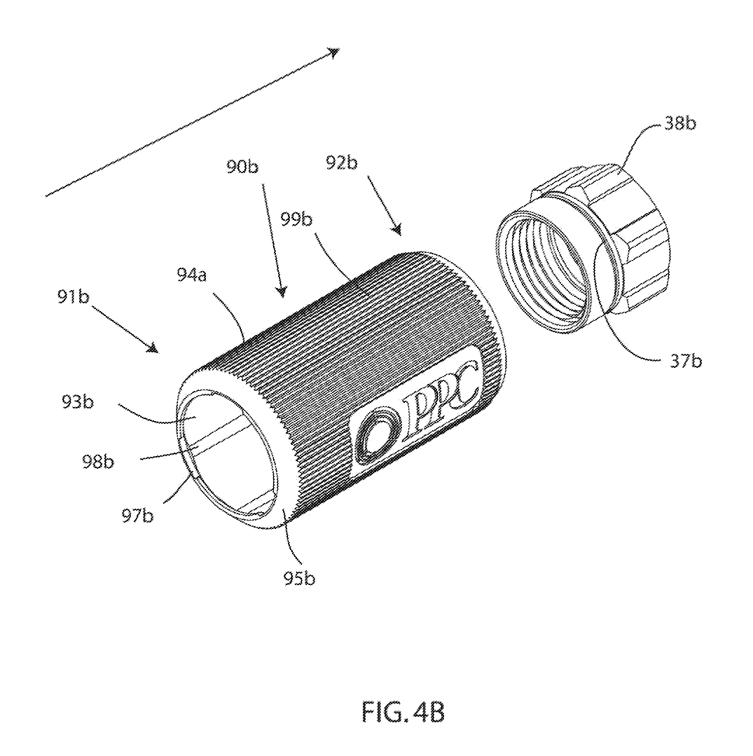

With reference to FIG. 4A, embodiments of connector 103 may include a coupling member 30b, a post 40, a connector body 50, an outer sleeve 90b, a compression portion 60, and a radial restriction member 65a.

Embodiments of a connector 103 may include a coupling member 30b. Coupling member 30b may share the same or substantially the same structural and functional aspects of coupling member 30a. Accordingly, coupling member 30b has a first forward end 31b, an opposing second rearward end 32b, internal threading 33b, an internal lip 34b including a surface 35b facing the first forward end 31b of the coupling member 30b. However, the second rearward end 32b, of the coupling member 30b may extend a significant axial distance to reside radially extent, or otherwise partially surround, a portion of the connector body 50, although the extended portion of the coupling member 30b need not contact the connector body 50. Additionally, coupling member 30b may include a retaining structure 37b on an outer surface 36b of the coupling member 30b. The retaining structure 37b may share the same or substantially same structural and functional aspects of the retaining structure 37a described in association with, for example, connector 100. Manufacture of the coupling member 30b may include casting, extruding, cutting, knurling, turning, tapping, drilling, injection molding, blow molding, combinations thereof, or other fabrication methods that may provide efficient production of the component. The forward facing surface 35b of the coupling member 30b faces a flange 44 the post 40 when operably assembled in a coaxial cable connector, so as to allow the coupling member 30b to rotate with respect to the other component elements, such as the post 40 and the connector body 50.

Embodiments of connector 103 may include an outer sleeve 90b. Sleeve 90b may share the same structural and functional aspects of sleeve 90a described in association with, for example, connector 100. Accordingly, sleeve 90b may include an engagement member 97b that is configured to mate or engage with a retaining structure 37b of the coupling member 30b. For example, the sleeve 90b may include a first end 91b, a second end 92b, an inner surface 93b, and an outer surface 94b, and may be a generally annular member having a generally axial opening therethrough. However, the sleeve 90b may be radially disposed over the coupling member 30b, or a portion thereof, the connector body 50, or a portion thereof, the compression portion 60, or a portion thereof, and the radial restriction member 65, while operably assembled and/or in a compressed position. Additionally, the sleeve 90b may include an annular ramped surface 95b or chamfer proximate or otherwise near the first end 91b to accommodate an increased diameter or general size of the coupling member 30b proximate a second, rearward end 32b of the coupling member 30b. Embodiments of the ramped surface 95b may be structurally integral with the engagement member 97b and the body of the sleeve 90b. Furthermore, embodiments of an assembled configuration of connector 103 with respect to the sleeve 90b may involve sliding the sleeve 90b over the coupling member 30b in an axial direction starting from the first end 31b and continuing toward the second end 32b of the coupling member 30b until sufficient mating and/or engagement occurs between the engagement member 97b of the sleeve 90b and the retaining structure 37b of the coupling member 30b, as shown in FIG. 4B. Sleeve 90b may also include outer surface feature(s) 99b, such as annular serrations or slots, configured to enhance gripping of the sleeve 90 while connecting the coaxial cable connector onto an interface port.

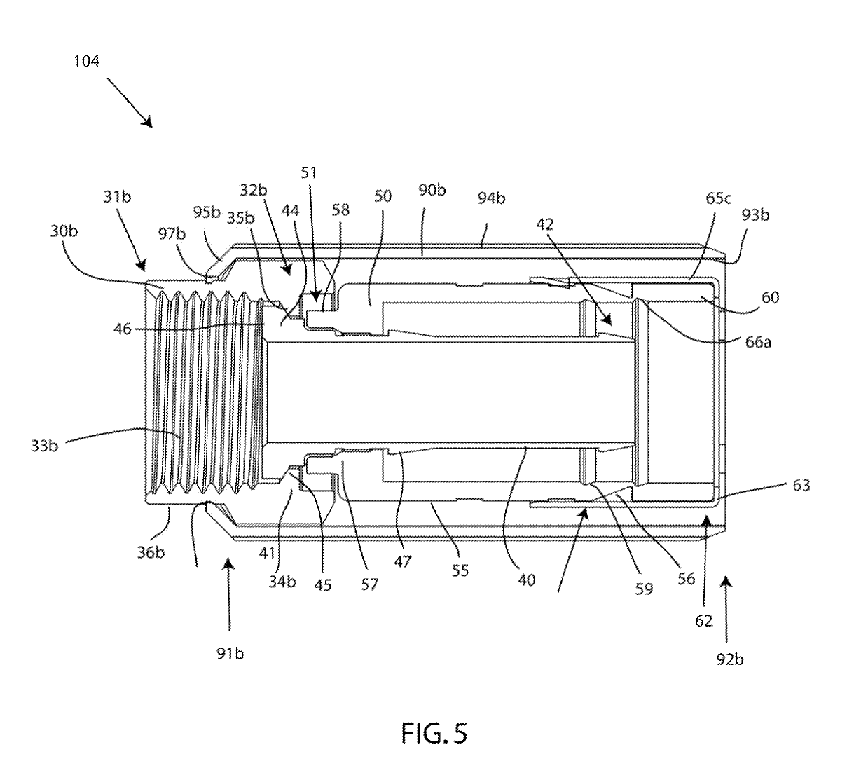

FIG. 5 depicts an embodiment of connector 104. Embodiments of connector 104 may include a coupling member 30b, a post 40, a connector body 50, an outer sleeve 90b, a compression portion 60, and a radial restriction member 65c.

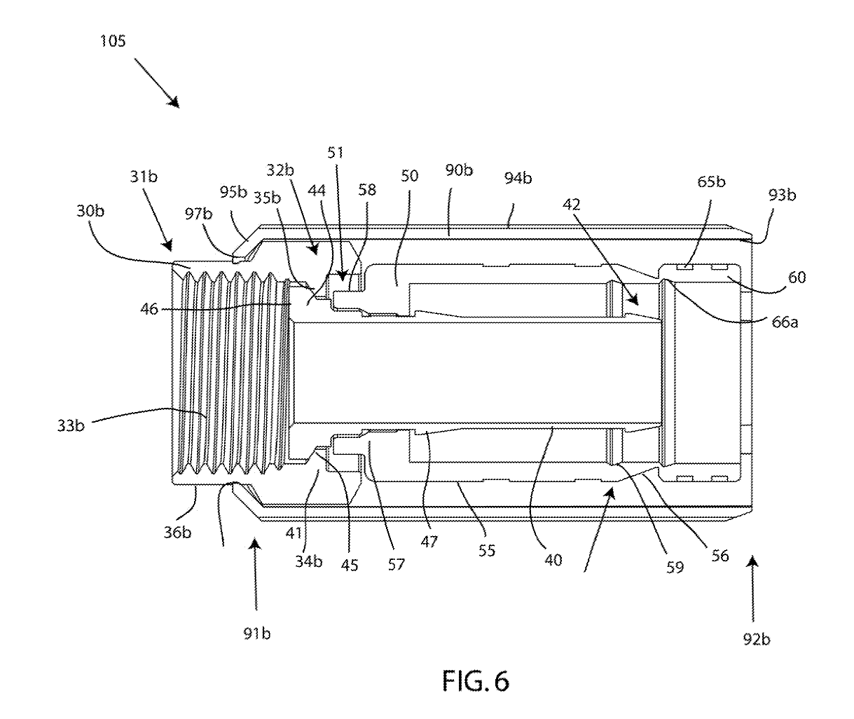

FIG. 6 depicts an embodiment of connector 105. Embodiments of connector 105 may include a coupling member 30b, a post 40, a connector body 50, an outer sleeve 90b, a compression portion 60, and a radial restriction member 65b

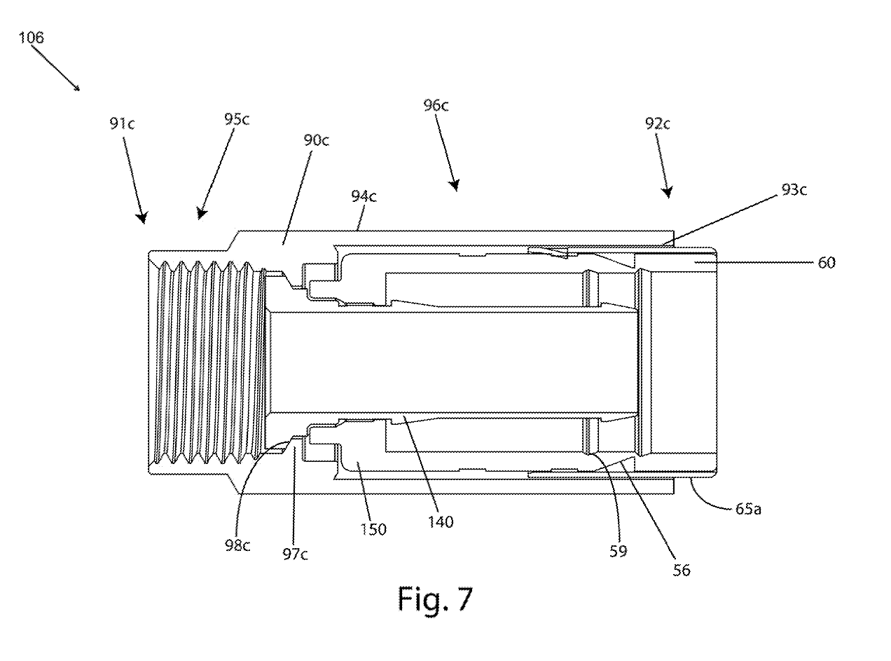

Referring now to FIG. 7, embodiments of connector 106 may include an integral sleeve 90c, a post 40, a connector body 50, a compression portion 60, and a radial restriction member 65a.

Embodiments of connector 106 may include an integral sleeve 90c. An integral sleeve 90c may be a generally annular member having a generally axial opening therethrough. The integral sleeve 90c may include a first end 91c, a second end 1392c, an outer surface 93c, and an outer surface 94c. Furthermore, the integral sleeve 90c may include a coupling portion 95c proximate the first end 91c and a body portion 96c structurally integral with the coupling portion 95c. The coupling portion 95c may include internal threads for operable engagement with an interface port, such as interface port 20. For instance, the internal threads of the coupling portion 95c of the integral sleeve 90c may correspond to threads on the outer surface of an interface port. The coupling portion 95c may also include an internal lip 97c, such as an annular protrusion. The internal lip 97c includes a surface 98c facing the first forward end 91c of the integral sleeve 90c. The forward facing surface 98c of the lip 97c may be a tapered surface that corresponds to a tapered surface 45 of the post 40. The forward facing surface 98c of the coupling portion 95c faces the flange 44 of the post 40 when operably assembled in a connector 106, so as to allow the integral sleeve 90c to rotate with respect to the other component elements, such as the post 40 and the connector body 50. The structural configuration of the coupling portion 95c of integral sleeve 90c may vary according to differing connector design parameters to accommodate different functionality of a coaxial cable connector. For instance, the first forward end 91c of the integral sleeve 90c may include internal and/or external structures such as ridges, grooves, curves, detents, slots, openings, chamfers, or other structural features, etc., which may facilitate the operable joining of an environmental sealing member, such a water-tight seal or other attachable component element, that may help prevent ingress of environmental contaminants, such as moisture, oils, and dirt, at the first forward end 91c of the integral sleeve 90c, when mated with an interface port 20. Those in the art should appreciate that the coupling portion 95c need not be threaded.

Moreover, the integral sleeve 90c includes a body portion 96c that may be structurally integral with the coupling portion 95c to form an outer sleeve that may surround the post 40, the connector body 50, the compression portion 60, or a portion thereof, and the radial restriction member 65, or a portion thereof when in an assembled and/or compressed position. Because the body portion 96c may be structurally integral with the coupling portion 95c, rotation or twisting of the body portion 96c can cause rotation or twisting of the coupling portion 95c to operably mate a coaxial cable connector, such as connector 106, onto an interface port. Thus, the integral sleeve 90c includes a larger surface area to grip and twist the integral sleeve 90c to thread the coupling portion 95c fully onto the interface port, such as interface port 20. Embodiments of the body portion 96c of the integral sleeve 90c may include outer surface features, such as annular serrations or slots, configured to enhance gripping of the integral sleeve 90c while connecting the coaxial cable connector onto an interface port. The body portion 96c of the sleeve 90c may be formed of materials such as plastics, polymers, bendable metals or composite materials that facilitate a rigid body, while the coupling portion 95c may be formed of conductive materials, such as copper, brass, aluminum, or other metals or metal alloys, facilitating grounding through the connector. In other words, the integral sleeve 90c may be formed of both conductive and non-conductive materials. For example, the external surface of the coupling portion 95c of the integral sleeve 90c may be formed of a polymer, while the remainder of the coupling portion 95c may be comprised of a metal or other conductive material. Alternatively, the coupling portion 95c and the body portion 96c of the integral sleeve 90c may be formed of conductive materials such as metals or metal alloys, or may both be formed of polymers or other materials that would facilitate a rigidly formed component. Manufacture of the integral sleeve 90c may include casting, extruding, cutting, knurling, turning, tapping, drilling, injection molding, blow molding, combinations thereof, or other fabrication methods that may provide efficient production of the component.

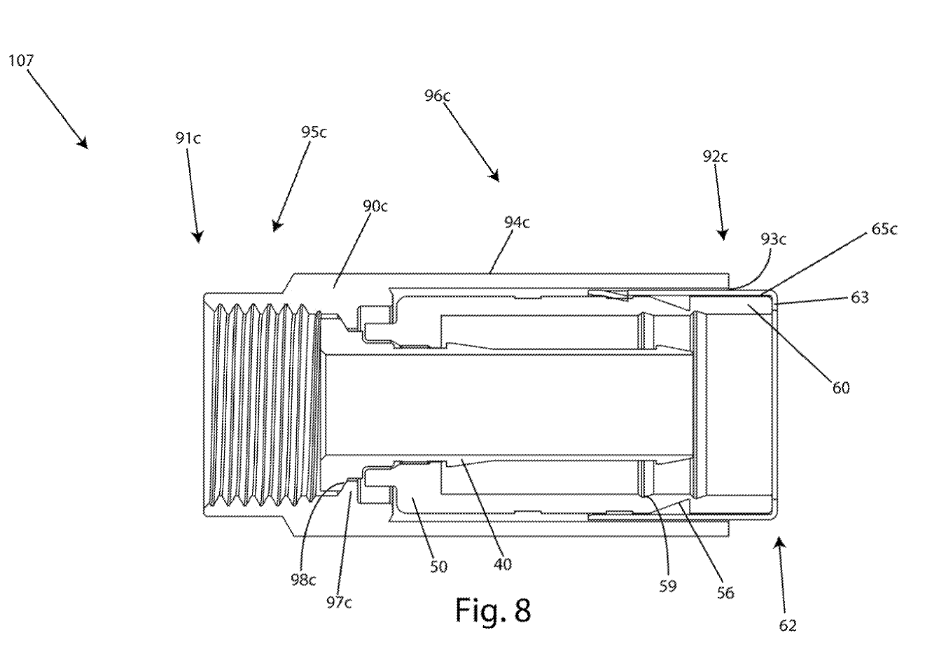

FIG. 8 depicts an embodiment of connector 107. Embodiments of connector 107 may include an integral sleeve 90c, a post 40, a connector body 50, a compression portion 60, and a radial restriction member 65c.

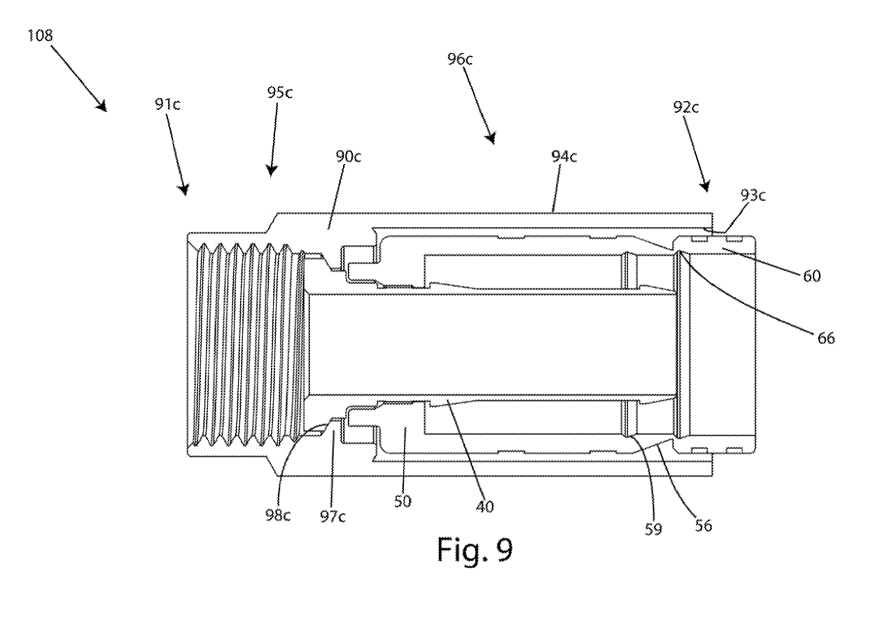

FIG. 9 depicts an embodiment of connector 108. Embodiments of connector 108 may include an integral sleeve 90c, a post 40, a connector body 50, a compression portion 60, and a radial restriction member 65b.

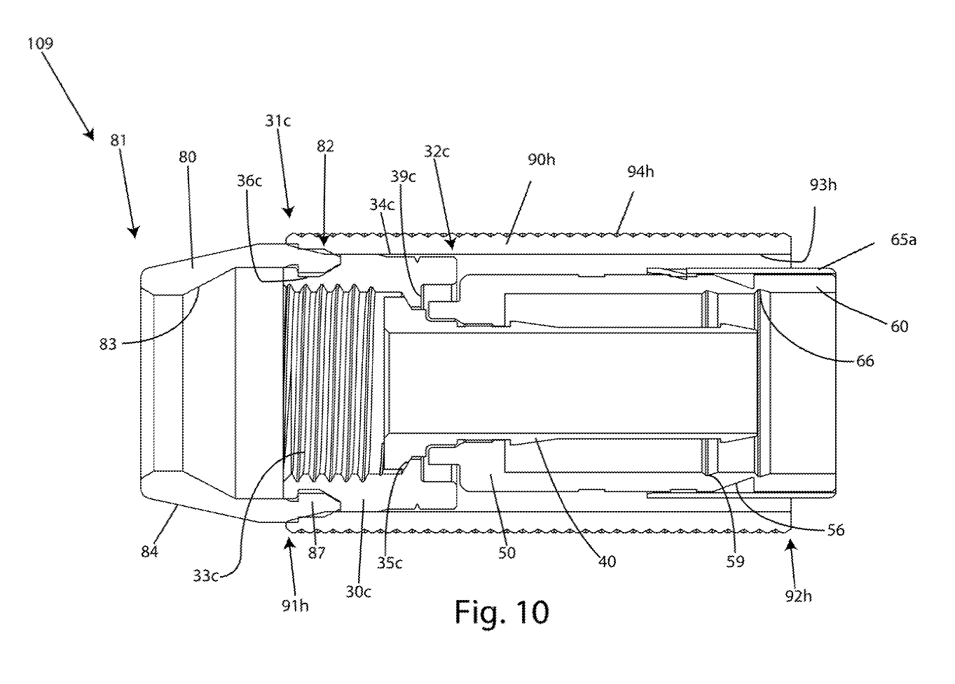

With reference now to FIG. 10, embodiments of connector 109 may include a coupling member 30c, a post 40, a connector body 50, a sleeve 90h, a sealing member 80, a compression portion 60, and a radial restriction member 65a.

Embodiments of connector 109 may include a coupling member 30c. Coupling member 30c may share some of the structural and functional aspects of embodiments of coupling member 30a, 30b, such as being mated, threaded or otherwise, to a corresponding interface port 20. Coupling member 30c may include a first end 31c, a second end 32c, an inner surface 33c, at least a portion of which is threaded, a connector-grasping portion 39c, and an outer surface 34c, including a seal-grasping surface portion 36c. The seal-grasping surface portion 36c may be a flat, smooth surface or a flat, roughened surface suitable to frictionally and/or adhesively engage an interior sealing surface 83 of the sealing member 80. Embodiments of the seal-grasping surface portion 36c may also contain a ridge that together with the seal grasping surface portion 36c forms a groove or shoulder that is suitably sized and shaped to correspondingly engage an internal shoulder 87 of the sealing member 80 adjacent the interior sealing surface 83 in a locking-type interference fit between the coupling member 30c and the sealing member 80.

Moreover, the coupling member 30c may further include a coupling member-turning surface portion on an outer surface 84 of the sealing member 80. The coupling member-turning surface portion may have at least two flat surface regions that allow engagement with the surfaces of a tool such as a wrench. In one embodiment, the coupling member-turning surface is hexagonal. Alternatively, the coupling member-turning surface may be a knurled surface to facilitate hand-turning of the nut component. Furthermore, upon engagement of the sealing member 80 with the coupling member 30c, a rear sealing surface of the sealing member 80 abuts a side/edge surface of the coupling member 30c to form a sealing relationship in that region. In one embodiment, the connector-grasping portion 36c of the coupling member 30c is an internally-projecting shoulder that engages a flange 44 of the post 40 in such a manner that the coupling member 30c can be freely rotated as it is held in place as part of the connector.

With continued reference to FIG. 10, connector 109 may include a sealing member 80. The sealing member may include a first end 81, a second end 82, an inner surface 83, and an outer surface 84. The sealing member 80 may have a generally tubular body that is elastically deformable by nature of its material characteristics and design. In most embodiments, the seal member 80 is a one-piece element made of a compression molded, elastomer material having suitable chemical resistance and material stability (i.e., elasticity) over a temperature range between about −40° C. to +40° C. For example, the sealing member 80 may be made of silicone rubber. Alternatively, the material may be propylene, a typical O-ring material. Other materials known in the art may also be suitable. Furthermore, the first end 81 of sealing member 80 may be a free end for ultimate engagement with a port, while the second end 82 may be for ultimate connection to the coupling member 30c. The sealing member 80 may have a forward sealing surface, a rear sealing portion including an interior sealing surface 83 that integrally engages the coupling member 30c, and an integral joint-section intermediate the first and second end 81, 82 of the tubular body of the sealing member 80. The forward sealing surface 85 at the first end 81 of the sealing member 80 may include annular facets to assist in forming a seal with the port, such as interface port 20. Alternatively, forward sealing surface 85 may be a continuous rounded annular surface that forms effective seals through the elastic deformation of the inner surface 83 and end of the sealing member 80 compressed against the port. The integral joint-section includes a portion of the length of the sealing member 80 which is relatively thinner in radial cross-section to encourage an outward expansion or bowing of the seal upon its axial compression. In an exemplary embodiment, the coupling member grasping surface includes an interior sealing surface which forms an annular surface on the inside of the tubular body, and an internal shoulder 87 of the tubular body adjacent the second end 82. Accordingly, compressive axial force may be applied against one or both ends of the seal depending upon the length of the port intended to be sealed. The force will act to axially compress the seal whereupon it will expand radially in the vicinity of the integral joint-section. In one embodiment, the integral joint-section is located axially asymmetrically intermediate the first end 81 and the second end 82 of the tubular body, and adjacent an anterior end of the interior sealing surface 83. Embodiments of the sealing member 80 may have an interior diameter at the integral joint-section equal to about 0.44 inches in an uncompressed state; the tubular body of the sealing member 80 may have a length from the first end 81 to the second end 82 of about 0.36 inches in an uncompressed state. However, it is contemplated that the joint-section can be designed to be inserted anywhere between she sealing surface and the first end 81. The sealing member 80 may prevent the ingress of corrosive elements when the seal is used for its intended function.

Referring still to FIG. 10, embodiments of connector 109 may include an outer sleeve 90h. The outer sleeve 90h may be engageable with coupling member 30c. Sleeve 90 h may share the same or substantially the same structural and functional aspects of sleeve 90a, described supra, and sleeve 90d, 90f, described infra. Accordingly, the sleeve 90h may include a first end 91h, a second end 92h, an inner surface 93h, and an outer surface 94h. However, the sleeve 90h need not include an engagement member, such as an embodiment of engagement member 97a. The mechanical interference to effectuate simultaneous rotation/twisting of the sleeve 90h and the coupling member 30c between coupling member 30c and sleeve 90h may rely on a press-fit or interference fit between the components. Alternatively, the sleeve 90h may and coupling member 30c may include corresponding internal (sleeve 90h) and external (coupling member 30c) surface features to facilitate mechanical interference between the components. Internal and external surface features of sleeve 90h and coupling member 30c may share the structural and functional aspects as surface features 98a and 38a, as described in association with, for example, connector 100.

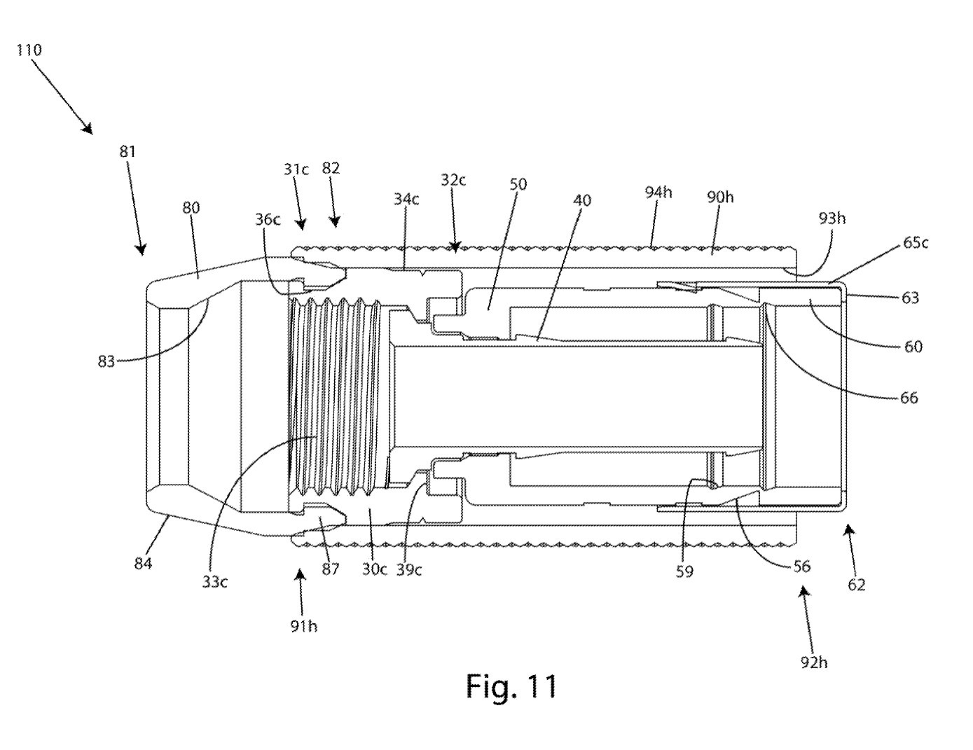

FIG. 11 depicts an embodiment of connector 110. Embodiments of connector 110 may include a coupling member 30c, a post 40, a connector body 50, a sleeve 90h, a sealing member 80, a compression portion 60, and a radial restriction member 65c.

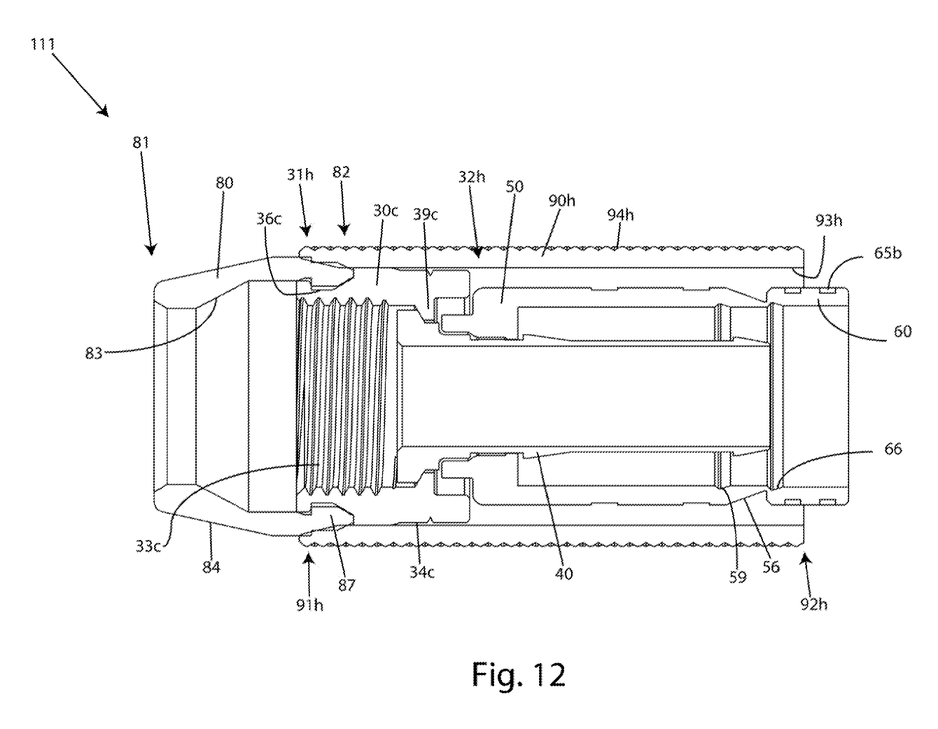

FIG. 12 depicts an embodiment of connector 111. Embodiments of connector 111 may include a coupling member 30c, a post 40, a connector body 50, a sleeve 90h, a sealing member 80, a compression portion 60, and a radial restriction member 65b.

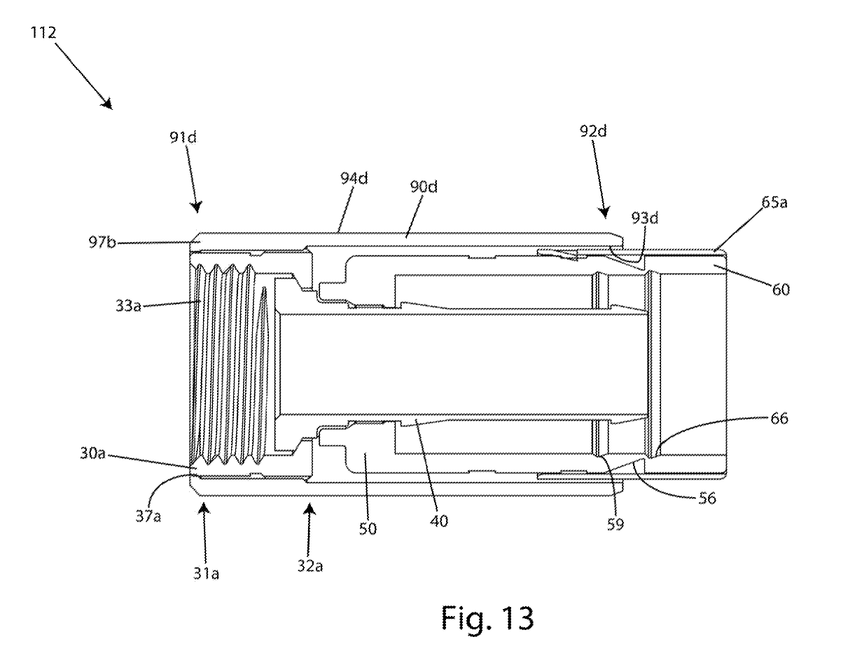

With continued reference to the drawings, FIG. 13 depicts an embodiment of connector 112. Embodiments of connector 112 may include a coupling member 30a, a post 40, a connector body 50, a sleeve 90d, a compression portion 60, and a radial restriction member 65a.

Embodiments of connector 112 may include a sleeve 90d. Sleeve 90d may be engageable with the coupling member 30a. Sleeve 90d may share the same or substantially the same structural and functional aspects of sleeve 90a. Accordingly, sleeve 90d may include an engagement member 97d that is configured to mate or engage with a retaining structure 37a of the coupling member 30a. Additionally, the sleeve 90d may include a first end 91d, a second end 92d, an inner surface 93d, and an outer surface 94d, and may be a generally annular member having a generally axial opening therethrough. Additionally, sleeve 90d may surround the coupling member 30a, the post 40, the connector body 50, or a portion thereof, the compression portion 60, and a radial restriction member 65, or a portion thereof when in an assembled and/or compressed position. However, the sleeve 90d may extend towards the first end 31a of coupling member 30a. In one embodiment, the first end 91d of the sleeve 90d may be flush or substantially flush with an edge of the coupling member 30a proximate or otherwise near the first end 31a of the coupling member 30a. Moreover, the engagement member 97d may be located proximate or otherwise near the edge of the first end 91d of the sleeve 90d. The engagement member 97d may be configured to mate or engage a retaining structure 37a of the coupling member 30a that is correspondingly located proximate or otherwise near the first end 31a of the coupling member 30a.

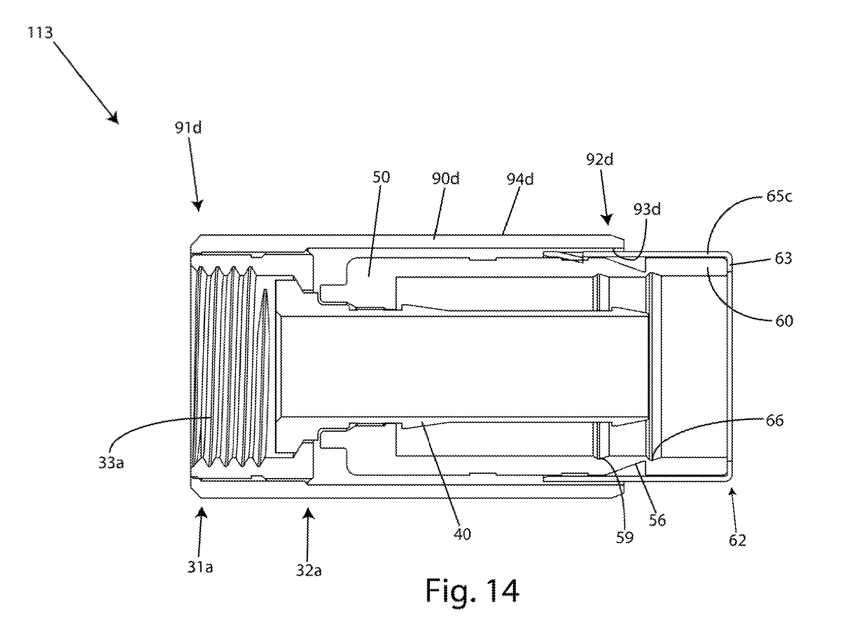

FIG. 14 depicts an embodiment of connector 113. Embodiments of connector 113 may include a coupling member 30a, a post 40, a connector body 50, an outer sleeve 90d, a compression portion 60, and a radial restriction member 65c.

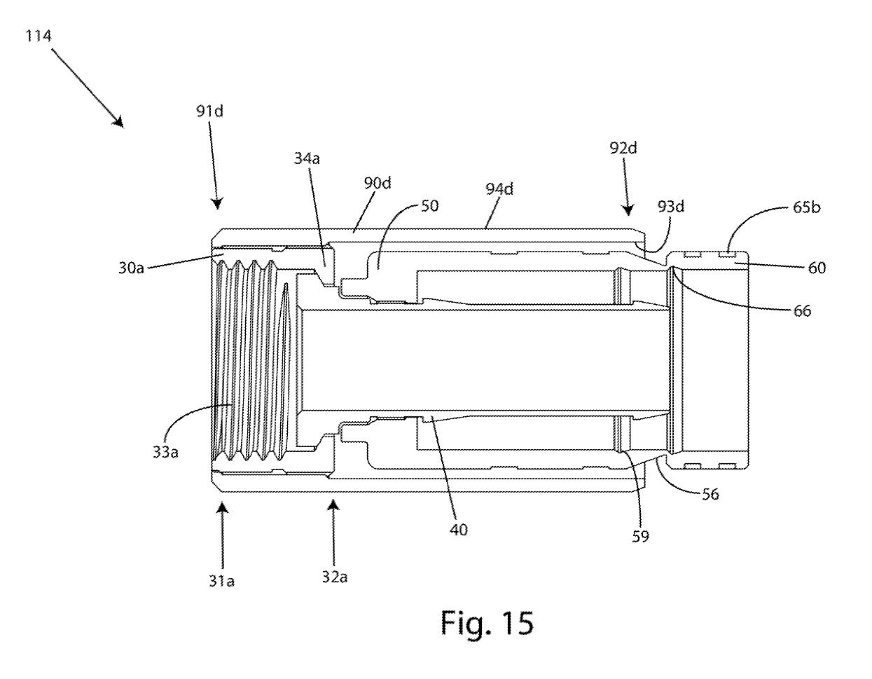

FIG. 15 depicts an embodiment of connector 114. Embodiments of connector 114 may include a coupling member 30a, a post 40, a connector body 50, an outer sleeve 90d, a compression portion 60, and a radial restriction member 65b.

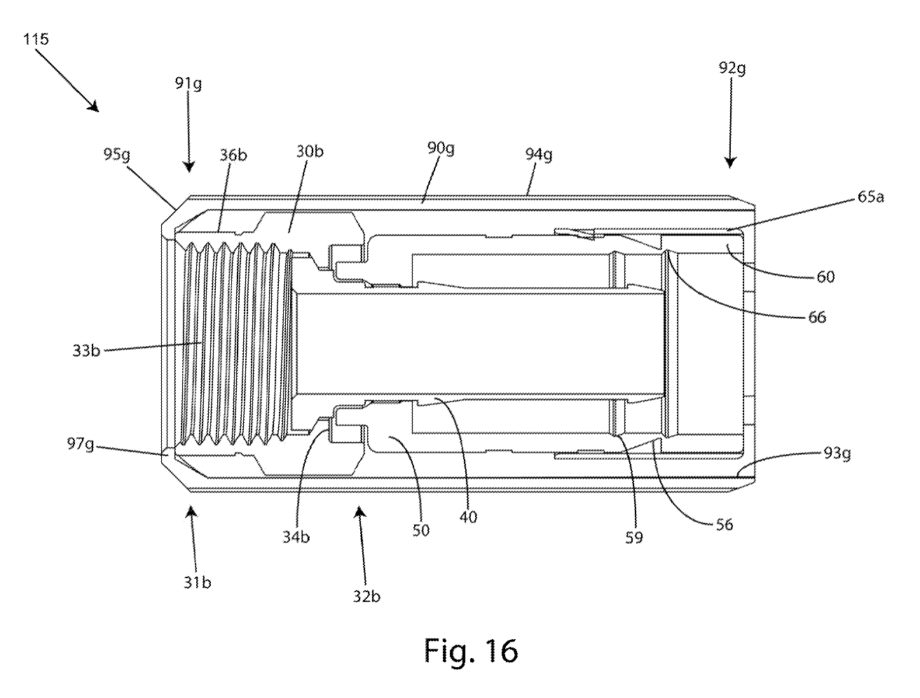

Referring now to FIG. 16, embodiments of connector 115 may include a coupling member 30b, a post 40, a connector body 50, an outer sleeve 90g, a compression portion 60, and a radial restriction member 65a.

Embodiments of connector 115 may include an outer sleeve 90g. Sleeve 90g may be engageable with the coupling member 30b. Sleeve 90g may share the same or substantially the same function as sleeve 90b and sleeve 90f described infra. Accordingly, the sleeve 90g may include a first end 91g, a second end 92g, an inner surface 93g, and an outer surface 94g, and may be a generally annular member having a generally axial opening therethrough. Sleeve 90g may surround the coupling member 30b, the post 40, the connector body 50, or a portion thereof, the compression portion 60, and a radial restriction member 65, or a portion thereof, when in an assembled and/or compressed position. Moreover, the sleeve 90g may extend towards the first end 31b of coupling member 30b. However, sleeve 90g may include an inwardly extending lip 97g proximate or otherwise near the first end 91g of the sleeve 90g, which can help guide the coupling member 30b onto a corresponding interface port. The lip 97g may share the same structural and functional aspects of the engagement member 97b. For instance, the lip 97g may radially inwardly extend a distance sufficient to prevent axial movement of the sleeve 90g in a direction towards the second end 32b of the coupling member 30b when operably assembled and/or in a compressed position. An embodiment of an assembled configuration of connector 115 with respect to the sleeve 90g may involve sliding the sleeve 90g over the coupling member 30b in an axial direction starting from the first end 31b and continuing toward the second end 32b of the coupling member 30b until sufficient mechanical interference and/or engagement occurs between the lip 97g of the sleeve 90g and frontal edge or mating surface of the coupling member 30b. The simultaneous rotation/twisting of the sleeve 90g and the coupling member 30b may be effectuated in the same or similar manner as described between the sleeve 90b and the coupling member 30b.

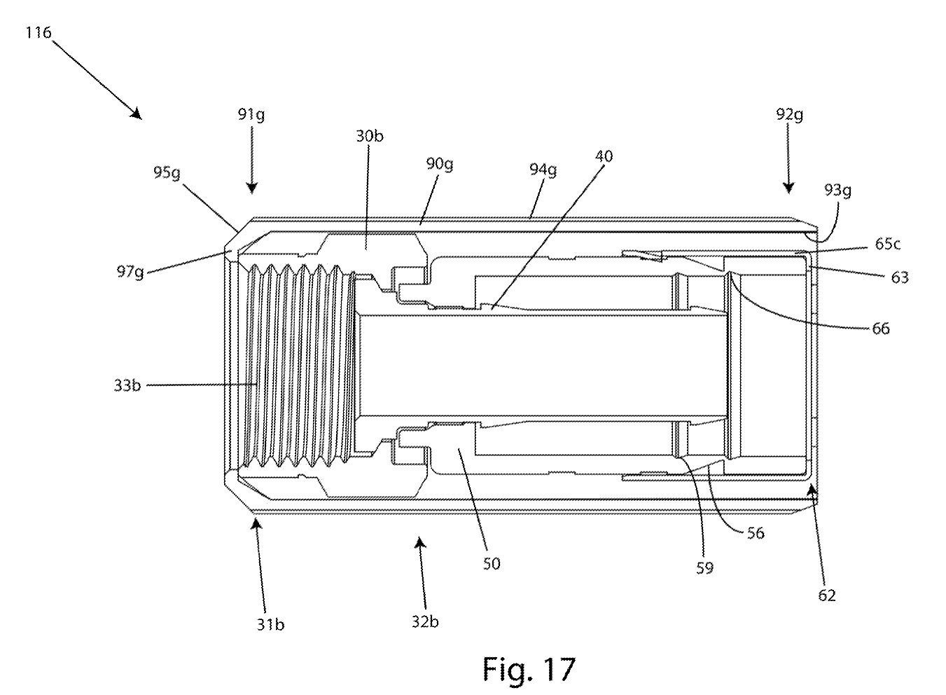

FIG. 17 depicts an embodiment of connector 116. Embodiments of connector 116 may include a coupling member 30b, a post 40, a connector body 50, an outer sleeve 90g, a compression portion 60, and a radial restriction member 65c.

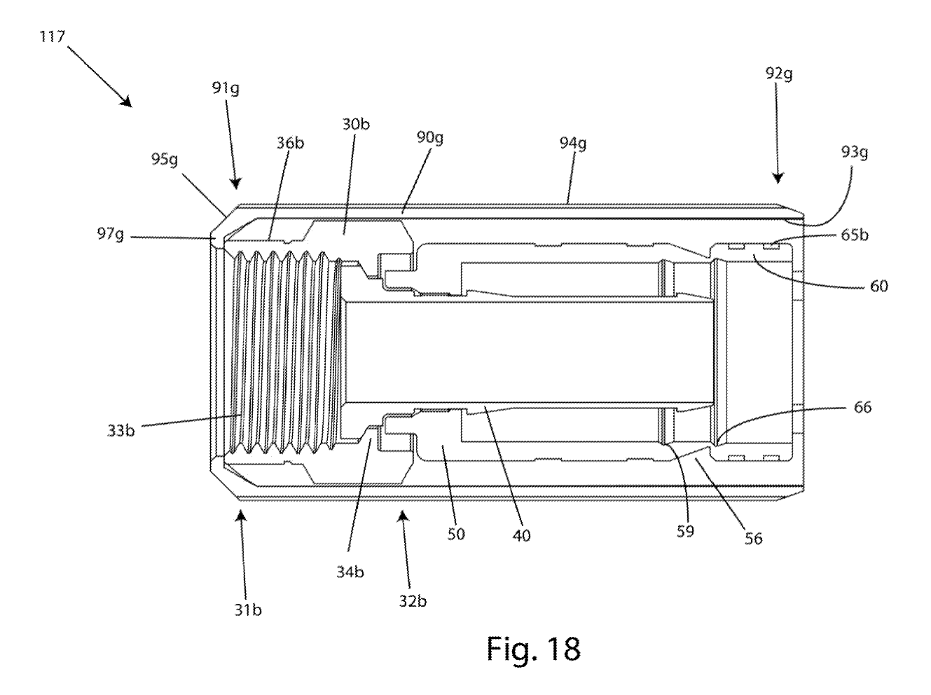

FIG. 18 depicts an embodiment of connector 117. Embodiments of connector 117 may include a coupling member 30b, a post 40, a connector body 50, an outer sleeve 90g, a compression portion 60, and a radial restriction member 65b.

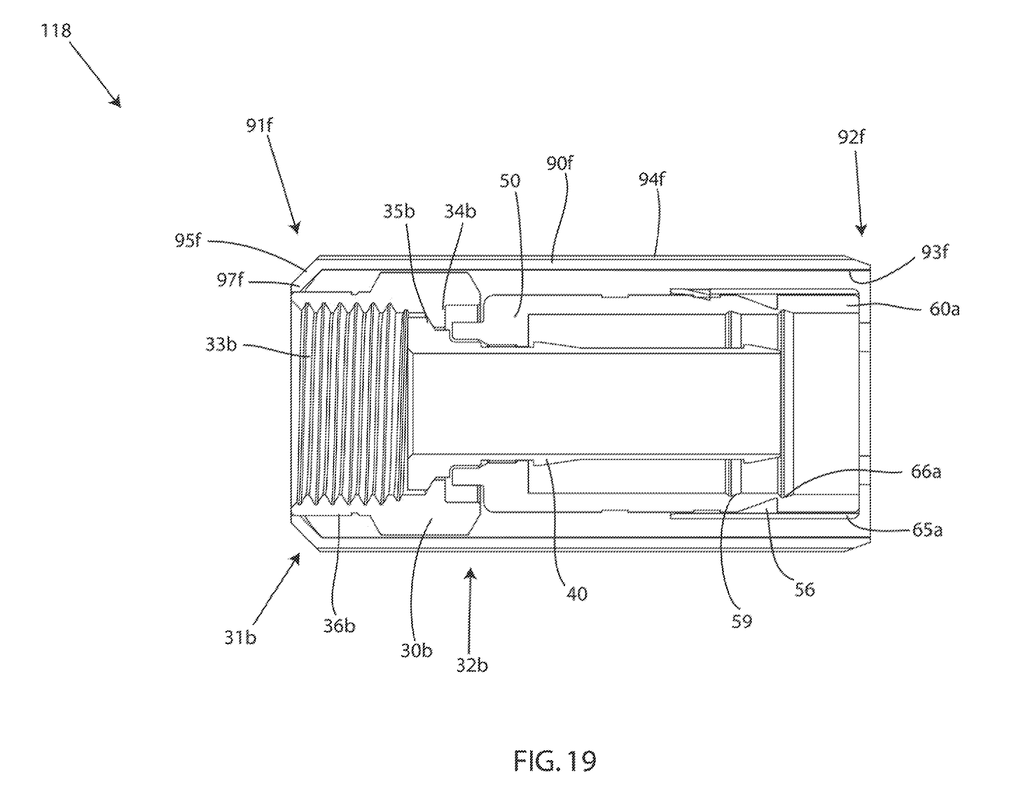

With reference now to FIG. 19, embodiments of connector 118 may include a coupling member 30b, a post 40, a connector body 50, an outer sleeve 90f, a compression portion 60, and a radial restriction member 65a.

Embodiments of connector 118 may include an outer sleeve 90f. Sleeve 90f may share the same or substantially the same structural and functional aspects of sleeve 90b. Accordingly, sleeve 90f may include an engagement member 97f that is configured to mate or engage with a retaining structure 37b of the coupling member 30b. For example, the sleeve 90f may include a first end 91f, a second end 92f, an inner surface 93f, and an outer surface 94f, and may be a generally annular member having a generally axial opening therethrough. Additionally, sleeve 90f may surround the coupling member 30b, the post 40, the connector body 50, or a portion thereof, the compression portion 60, and a radial restriction member 65, or a portion thereof when in an assembled and/or compressed position. However, the sleeve 90f may extend towards the first end 31b of coupling member 30b. In one embodiment, the first end 91f of the sleeve 90f may be flush or substantially flush with an edge of the coupling member 30b proximate or otherwise near the first end 31b of the coupling member 30b. Moreover, the engagement member 97f may be located proximate or otherwise near the edge of the first end 91f of the sleeve 90f. The engagement member 97f may be configured to mate or engage a retaining structure 37b of the coupling member 30b that is correspondingly located proximate or otherwise near the first end 31b of the coupling member 30b.

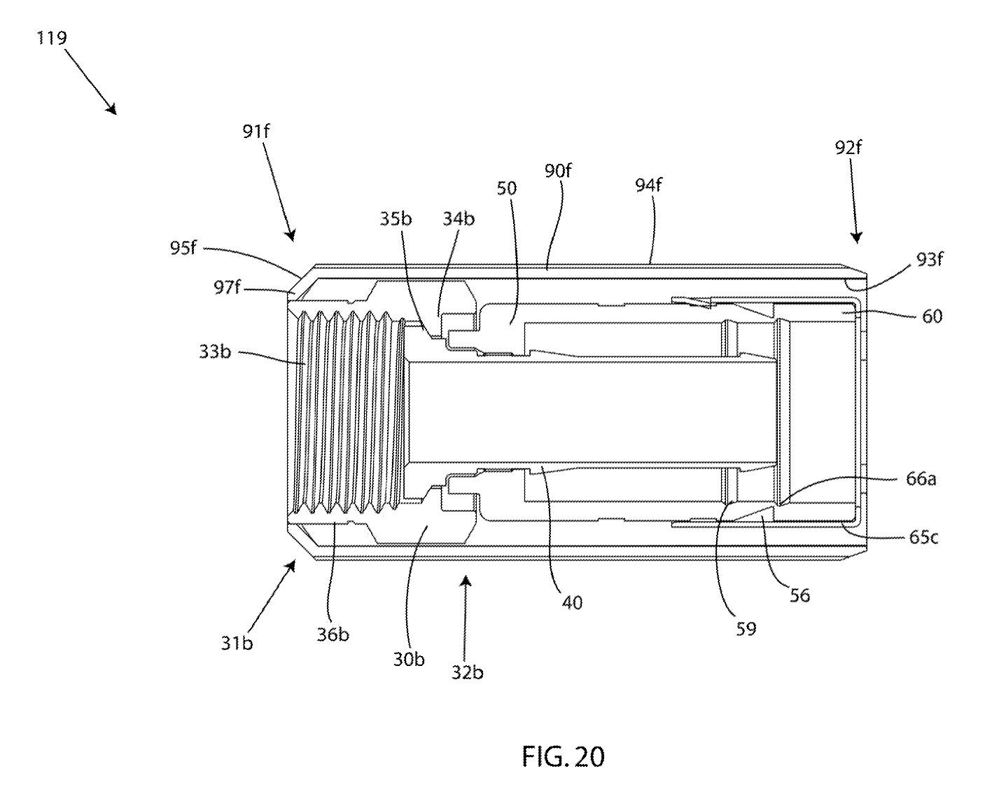

FIG. 20 depicts an embodiment of connector 119. Embodiments of connector 119 may include a coupling member 30b, a post 40, a connector body 50, an outer sleeve 90f, a compression portion 60, and a radial restriction member 65c.

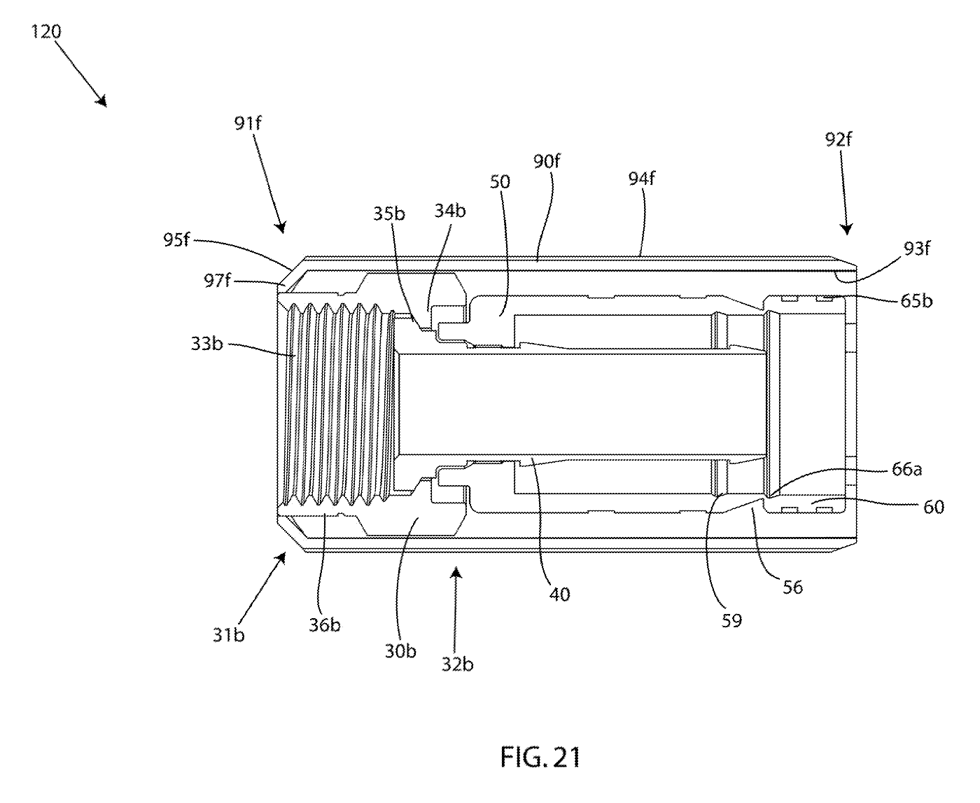

FIG. 21 depicts an embodiment of connector 120. Embodiments of connector 120 may include a coupling member 30b, a post 40, a connector body 50, an outer sleeve 90f, a compression portion 60, and a radial restriction member 65b.

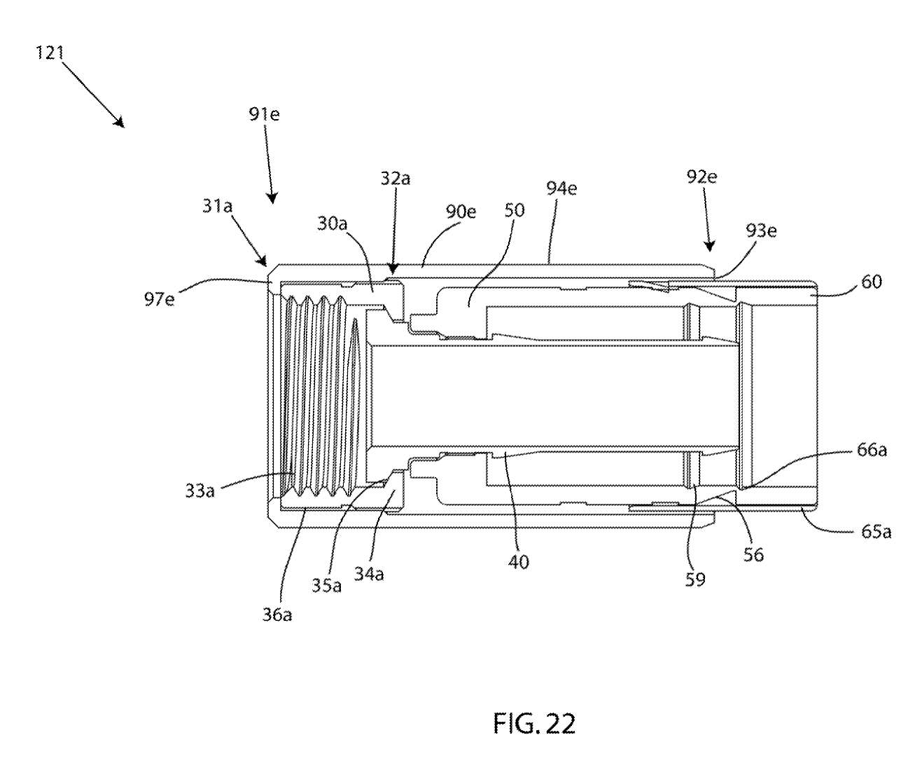

Referring now to FIG. 22, embodiments of connector 121 may include a coupling member 30a, a post 40, a connector body 50, an outer sleeve 90e, a compression portion 60, and a radial restriction member 65a.

Embodiments of connector 121 may include an outer sleeve 90e. Sleeve 90e may share the same or substantially the same function as sleeve 90a and sleeve 90d. Accordingly, the sleeve 90e may include a first end 91e, a second end 92e, an inner surface 93e, and an outer surface 94e, and may be a generally annular member having a generally axial opening therethrough. Sleeve 90e may surround the coupling member 30a, the post 40, the connector body 50, or a portion thereof, the compression portion 60, and a radial restriction member 65, or a portion thereof when in an assembled and/or compressed position. Moreover, the sleeve 90e may extend towards the first end 31a of coupling member 30a. However, sleeve 90e may include an inwardly extending lip 97e proximate or otherwise near the first end 91e of the sleeve 90e, which can help guide the coupling member 30a onto a corresponding interface port. The lip 97e may share the same functional aspects of the engagement member 97a, 97d of sleeve 90a, 90d, respectively. For instance, the lip 97e may radially inwardly extend a distance sufficient to prevent axial movement of the sleeve 90e in a direction towards the second end 32a of the coupling member 30a when operably assembled and/or in a compressed position. An embodiment of an assembled configuration of connector 121 with respect to the sleeve 90e may involve sliding the sleeve 90e over the coupling member 30a in an axial direction starting from the first end 31a and continuing toward the second end 32a of the coupling member 30a until sufficient mechanical interference and/or engagement occurs between the lip 97e of the sleeve 90e and frontal edge or mating surface of the coupling member 30a. The simultaneous rotation/twisting of the sleeve 90e and the coupling member 30a may be effectuated in the same or similar manner as described between the sleeve 90a and the coupling member 30a.

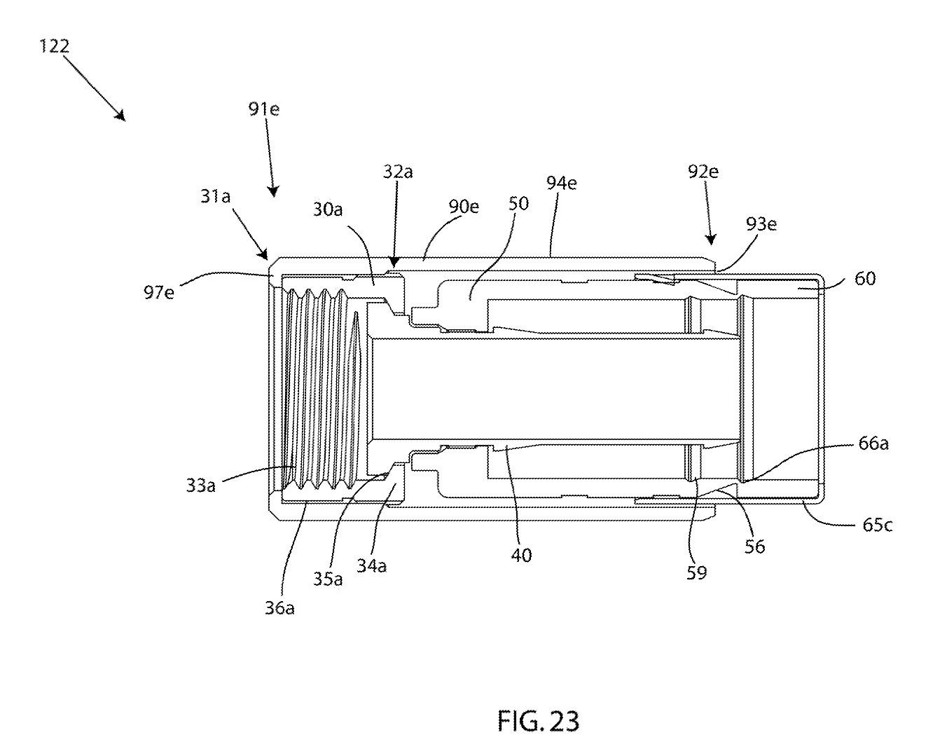

FIG. 23 depicts an embodiment of connector 122. Embodiments of connector 122 may include a coupling member 30b, a post 40, a connector body 50, an outer sleeve 90e, a compression portion 60, and a radial restriction member 65c.

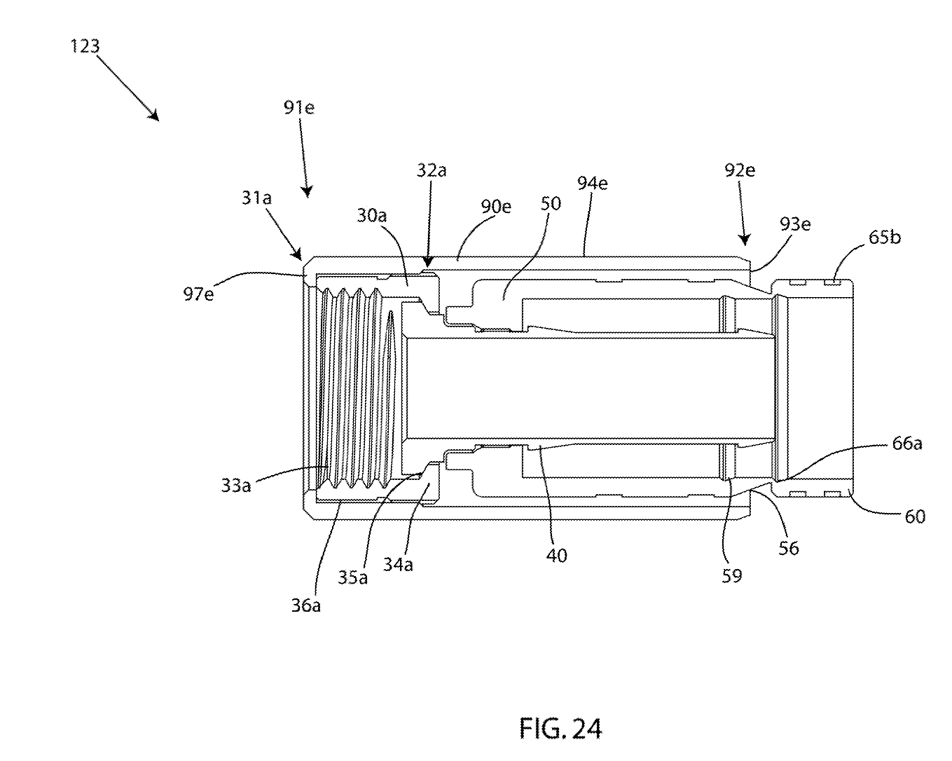

FIG. 24 depicts an embodiment of connector 123. Embodiments of connector 123 may include a coupling member 30b, a post 40, a connector body 50, an outer sleeve 90e, a compression portion 60, and a radial restriction member 65b

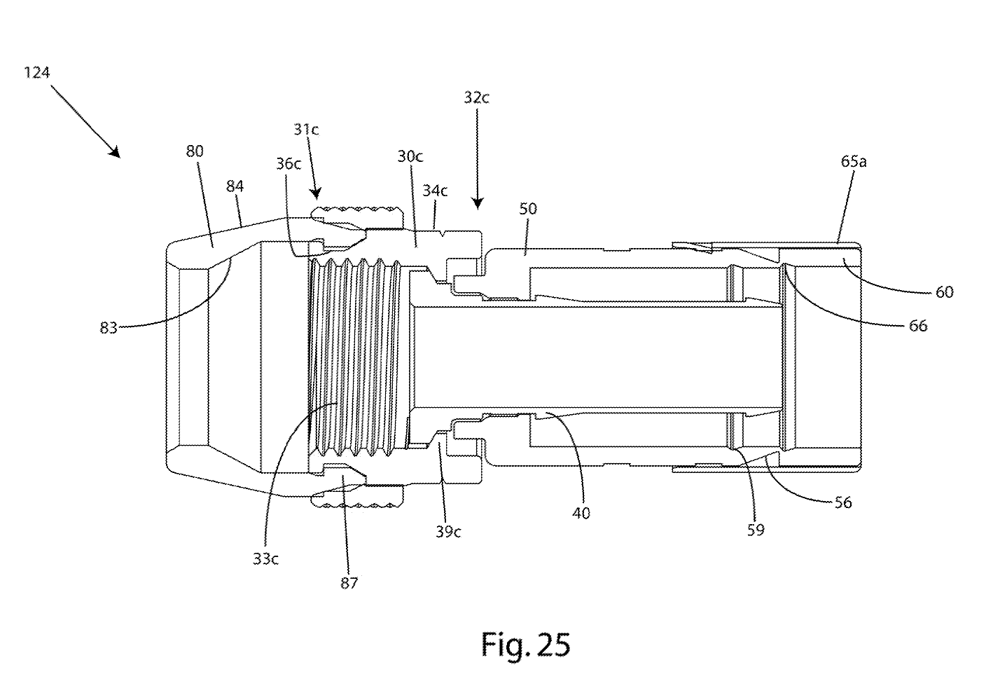

Continuing to refer to the drawings, FIGS. 25-27 depict an embodiment of connector 124-128 that may include a coupling member 30c, a post 40, a seal member 80, a connector body 50, a connector body seal element 5, a compression portion 60, and a radial restriction member 65. Embodiments of a radial restriction member 65 may be radial restriction member 65a, radial restriction member 65b, or radial restriction member 65c.

Referring to FIG. 25, embodiments of connector 124 may include a coupling member 30c, a post 40, a connector body 50, a sealing member 80, a connector body seal element 5, a compression portion 60, and a radial restriction member 65a.

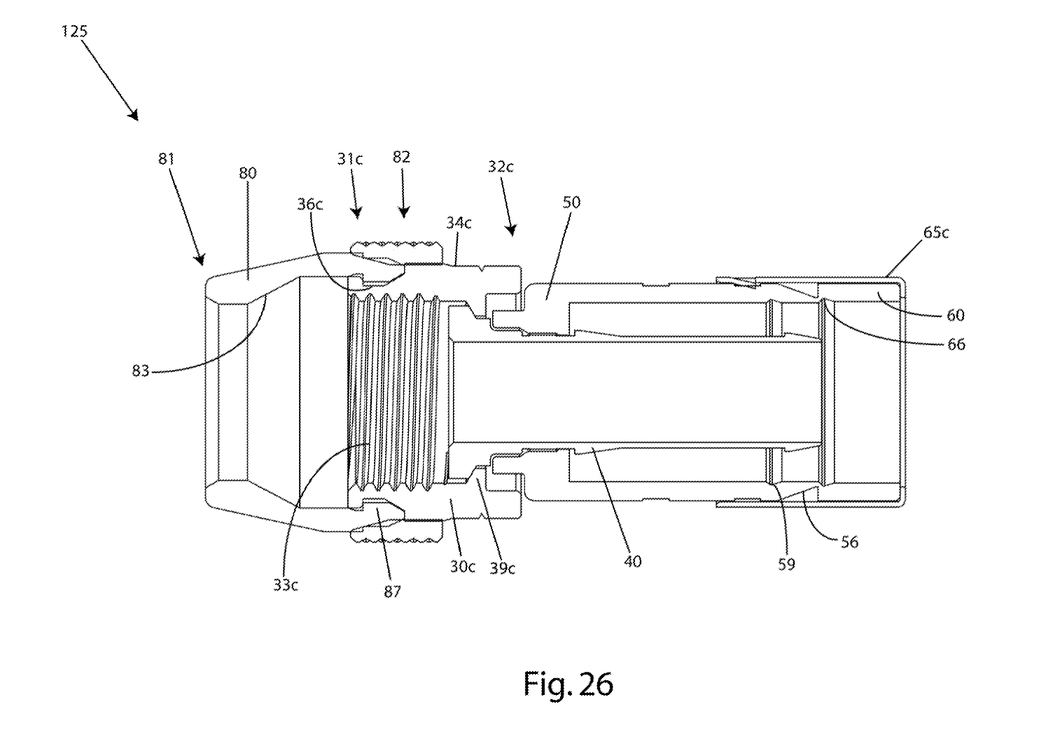

FIG. 26 depicts an embodiment of connector 125. Embodiments of connector 125 may include a coupling member 30c, a post 40, a connector body 50, a sealing member 80, a compression portion 60, and a radial restriction member 65c.

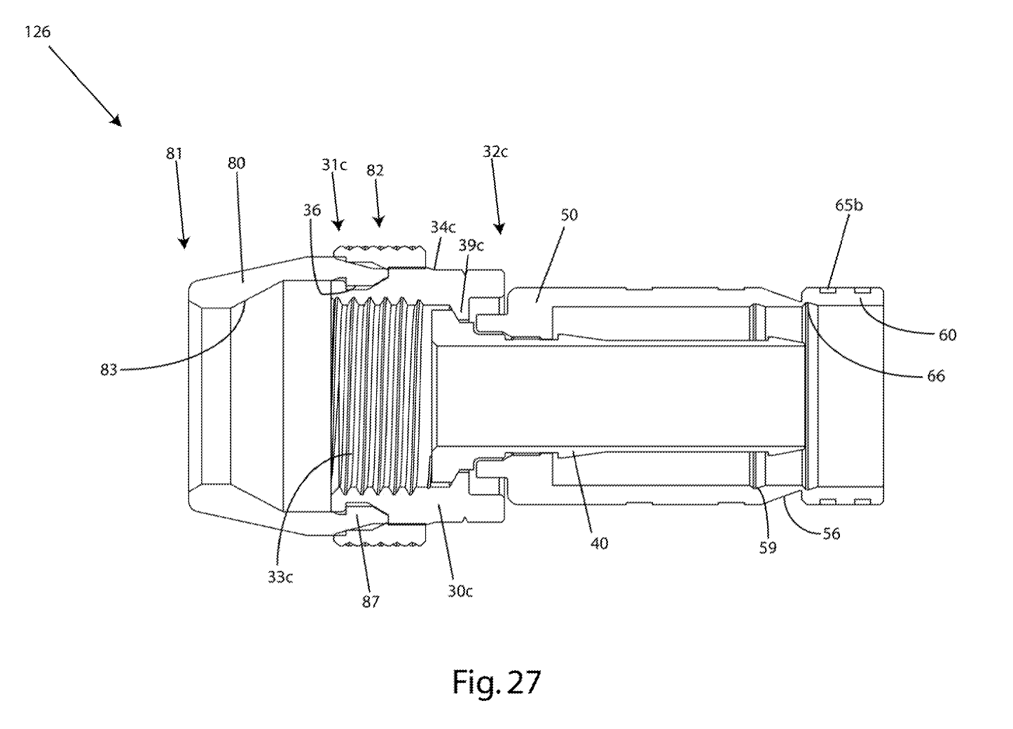

FIG. 27 depicts an embodiment of connector 126. Embodiments of connector 127 may include a coupling member 30c, a post 40, a connector body 50, a sealing member 80, a compression portion 60, and a radial restriction member 65b.

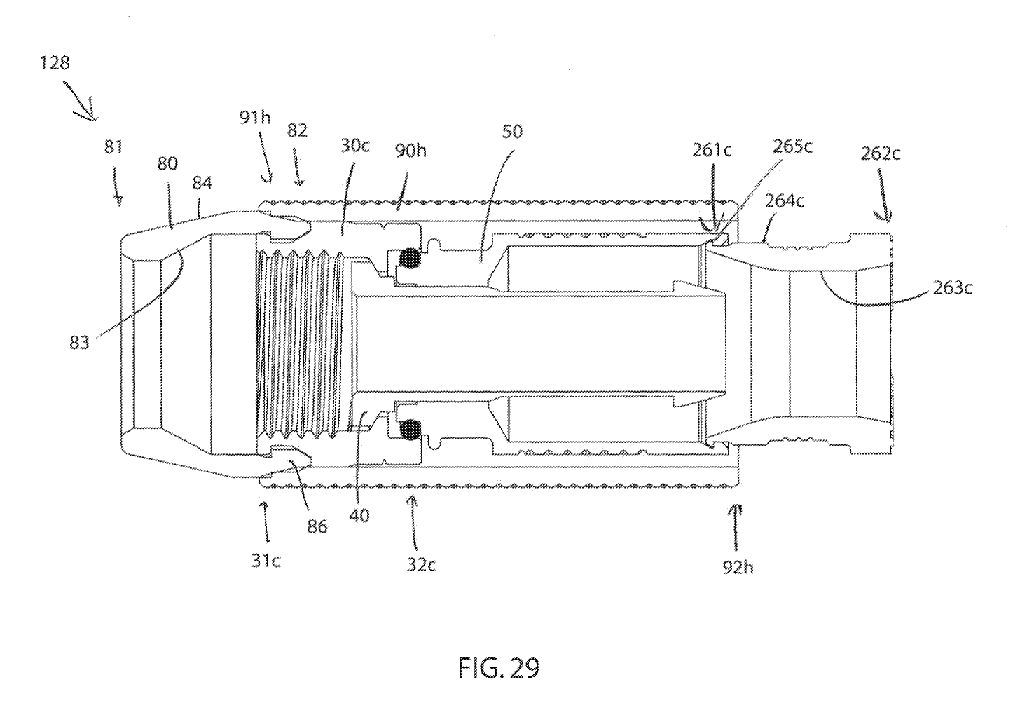

With reference to FIGS. 28 and 29, embodiments of connector 127-128 may include a coupling member 30c, a post 40, a seal member 80, a connector body 50, a sleeve 90h, a connector body seal element 5, and a compression portion 260. Embodiments of a compression portion 260 may be compression portion 260b or compression portion 260c.

FIG. 28 depicts an embodiment of connector 127. Embodiments of connector 127 may include a coupling member 30c, a post 40, a connector body 50, a connector body seal member 5, a sleeve 90h, and a compression portion 260b.

Embodiments of connector 127 may include a compression portion 260b. Compression portion 260b may be a fastener member that is inserted over the connector body 50 to deformably compress the connector body 50 onto the cable 10. The compression portion 260b may have a first end 261 and opposing second end 262. In addition, the compression portion 260 may include an internal annular protrusion 263 located proximate the first end 261 of the compression portion 260b and configured to mate and achieve purchase with the annular detent 53 on the outer surface 55 of connector body 50. Moreover, the compression portion 260b may comprise a central passageway defined between the first end 261 and second end 262 and extending axially through the compression portion 260b. The central passageway may comprise a ramped surface 266 which may be positioned between a first opening or inner bore having a first diameter positioned proximate with the first end 261 of the compression portion 260b and a second opening or inner bore having a second diameter positioned proximate with the second end 262 of the compression portion 260b. The ramped surface 266 may act to deformably compress the outer surface 55 of a connector body 50 when the compression portion 260b is operated to secure a coaxial cable 10. For example, the narrowing geometry will compress squeeze against the cable, when the compression portion is compressed into a tight and secured position on the connector body. Additionally, the compression portion 260b may comprise an exterior surface feature 269 positioned proximate with or close to the second end 262 of the compression portion 260b. The surface feature 269 may facilitate gripping of the compression portion 260b during operation of the connector. Although the surface feature 269 is shown as an annular detent, it may have various shapes and sizes such as a ridge, notch, protrusion, knurling, or other friction or gripping type arrangements. It should be recognized, by those skilled in the requisite art, that the compression portion 260b may be formed of rigid materials such as metals, hard plastics, polymers, composites and the like, and/or combinations thereof. Furthermore, the compression portion 260b may be manufactured via casting, extruding, cutting, turning, drilling, knurling, injection molding, spraying, blow molding, component overmolding, combinations thereof, or other fabrication methods that may provide efficient production of the component.

FIG. 29 depicts an embodiment of connector 128. Embodiments of connector 128 may include a coupling member 30c, a post 40, a connector body 50, a sealing member 80, a connector body seal member 5, a sleeve 90h, and a compression portion 260c.

Embodiments of connector 128 may include a compression portion 260c. Compression portion 260c may be an insertable compression sleeve or tubular locking compression member that resides internally with respect to the connector body 50 in the compressed position. The compression portion 260c may include a first end 261c, a second end 262c, an inner surface 263, and an outer surface 264c. The compression portion 260c may be pushed into the connector body 50 to squeeze against and secure the cable 10. For instance, the compression portion 260c may protrude axially into an annular chamber through the rear opening, and may be slidably coupled or otherwise movably affixed to the connector body 50 to compress into the connector body 50 and retain the cable 10. The compression portion 260c may be displaceable or movable axially or in the general direction of the axis of the connector between a first open position (accommodating insertion of the tubular inner post 40 into a prepared cable 10 end to contact the grounding shield 14), and a second clamped position compressibly fixing the cable 10 within the chamber of the connector because the compression portion 260c is squeezed into retraining contact with the cable 10 within the connector body 50. Furthermore, the compression portion 260c may include a lip 265c proximate the first end 261c, wherein the lip 265c of the compression portion 260c mates with the internal groove of the connector body 50.

Further embodiments of a coaxial cable connector may include a coupling member 30, a post 40, a connector body 50, a sealing member 80, a connector body seal member 5, a sleeve 90, a compression portion 60/260, and a radial restriction member 65a/65b/65c. Embodiments of sleeve 90 may include sleeve 90a/90b/90d/90e/90f/90g/90h, or may simply share the same structural and functional aspects, yet be configured to operably attach to a coupling member having molded plastic threads, or a coupling member that is completely molded. Embodiments of a coupling member 30, which may share the same or substantially the same structural and functional aspects of 30a/30b/30c, may include plastic threads designed to seal against the external threads 23 of port 20 to keep moisture and other physical contaminants out. For example, the threads may be cut slightly different resulting in a differently shaped or dimensioned thread from the threads 23 of the port 20 to achieve a seal with the port 20. Furthermore, the threads could be slightly over-sized causing the metallic threads 23 of the port 20 to slice, pierce, grind, etc., into and against the plastic threads of the plastic coupling member 30 as the plastic coupling member 30 is being threaded onto the port 20. The threads can be molded or machined, and the coupling member 30 can be all plastic (molded or machined) or the coupling member 30 can have a plastic insert that has molded or cut threads. Additionally, the plastic threads may be shaped like pipe-threads causing the non-pipe-thread-shaped threads of the port 20 to seal against the plastic threads of the coupling member 30 when the coupling member 30 is advanced onto the port 20. The threads may also include a small protrusion feature running along the threads that forms a seal with the threads of the port 20 as the coupling member 30 is advanced onto the port 20. Embodiments of a plastic coupling member (or partially plastic coupling member having plastic threads), in addition to creating a physical seal, may inherently create a secure connection to the port 20 because a tight friction-fit may likely be formed with the port 20 as the threads of the coupling member 30 are advanced (with some amount of force that may be necessary to overcome the friction) onto the threads of the port 20.

Those skilled in the art should appreciate that various combinations and embodiments disclosed and described in detail herein may include a body seal element, such as connector body seal element 5, to provide an environmental seal for the coaxial cable connector.

With reference to FIGS. 1-29, a method of fastening a coaxial cable, such as coaxial cable 10, to a communication port, such as port 20. The method may comprise a step of providing a coaxial cable connector 100-128 including: a connector body 50, a post 40 operably attached to the connector body 50, the post 40 having a flange 44, a coupling member 30a/30b/30c axially rotatable with respect to the post 40 and the connector body 50, the coupling member 30a/30b/30c including a lip 34a/34b/36c, an outer sleeve 90a/90b/90c/90d/90e/90f/90g/90h engageable with the coupling member 30a/30b/30c, and a compression portion 60 structurally integral with the connector body 50. Another method step may include axially compressing the compression portion 60 to form an environmental seal around the coaxial cable 10, wherein when axially compressed, the compression portion 60 breaks away from the connector body 50 and securely connects to the coaxial cable 10. Still another method step may include fastening the coupling member 30a/30b/30c to an interface port by operating the outer sleeve 90a/90b/90c/90d/90e/90f/90g/90h.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims. The claims provide the scope of the coverage of the invention and should not be limited to the specific examples provided herein.

1. A coaxial cable connector comprising;
a connector body;
a post, engageable with the connector body;
a coupling member, axially rotatable with respect to the connector body, the coupling member having a first end and opposing second end;
an outer sleeve engageable with the coupling member, the sleeve configured to rotate the coupling member;
a compression portion structurally integral with the connector body, wherein the compression portion is configured to break apart from the body when axially compressed; and
a radial restriction member, wherein at least some part of the radial restriction member is disposed radially extent of the compression portion to restrict radial expansion of the compression portion.

2. (canceled)

3. The coaxial cable connector of claim 1, wherein the radial restriction member comprises at least one strap positioned around at least a section of the compression portion.

4. The coaxial cable connector of claim 1, wherein the radial restriction member includes an inwardly extending lip.

5. The coaxial cable connector of claim 1, wherein the outer sleeve extends to the first end of the coupling member.

6. The coaxial cable connector of claim 1, wherein the outer sleeve extends beyond the first end of the coupling member, to guide the coupling member onto a corresponding port.

7. The coaxial cable connector of claim 1, wherein the outer sleeve includes an engagement member configured to mate with a retaining structure of the coupling member.

8. A coaxial cable connector comprising;
a connector body;
a post engageable with connector body;
a coupling member, axially rotatable with respect to the connector body, the coupling member having a first end and opposing second end portion;
a sealing element attached to the first end of the coupling member, wherein the sealing element prevents ingress of environmental elements proximate the first end of the coupling member that is configured to mate with a port; and
an outer sleeve engageable with the coupling member, the sleeve configured to rotate the coupling member.

9. The coaxial cable connector of claim 8, further comprising a compression portion.

10. The coaxial cable connector of claim 9, wherein the compression portion is a separate fastener member radially disposed over the connector body to radially compress the connector body onto a coaxial cable.

11. The coaxial cable connector of claim 9, wherein the compression portion is a separate insertable compression sleeve configured to be inserted within an opening of the connector body proximate a rearward end of the connector body.

12. The coaxial cable connector of claim 8, wherein the outer sleeve extends to the first end of the coupling member.

13. The coaxial cable connector of claim 8, wherein the outer sleeve includes an engagement member configured to mate with a retaining structure of the coupling member.

14. A coaxial cable connector comprising;
a connector body;
a post engageable with connector body;
a coupling member, axially rotatable with respect to the connector body, the coupling member having a first end and opposing second end;
a sealing element attached to the first end of the coupling member, wherein the sealing element prevents ingress of environmental elements proximate the first end of the coupling member that is configured to mate with a port; and
a compression portion structurally integral with the connector body, wherein the compression portion is configured to break apart from the body when axially compressed.

15. The coaxial cable connector of claim 14, further comprising a radial restriction member, wherein at least some part of the radial restriction member is disposed radially extent of the compression portion to restrict radial expansion of the compression portion.

16. The coaxial cable connector of claim 15, wherein the radial restriction member comprises at least one strap positioned around at least a section of the compression portion.

17. The coaxial cable connector of claim 15, wherein the radial restriction member includes an inwardly extending lip.

18. A method of fastening a coaxial cable to a communication port, the method comprising:
providing a coaxial cable connector including:
a connector body;
a post operably attached to the connector body;
a coupling member axially rotatable with respect to the connector body;
an outer sleeve engageable with the coupling member;
a compression portion structurally integral with the connector body; and
a radial restriction member, wherein at least some part of the radial restriction member is disposed radially extent of the compression portion to restrict radial expansion of the compression portion;
axially compressing the compression portion to form an environmental seal around the coaxial cable, wherein when axially compressed, the compression portion breaks away from the body and securely connects to the coaxial cable; and
fastening the coupling member to an interface port by operating the outer sleeve.

19. A coaxial cable connector comprising;
a connector body;
a post engageable with connector body;
a coupling member, axially rotatable with respect to the connector body, the coupling member having a first end and opposing second end;
a sealing element attached to the first end of the coupling member, wherein the sealing element prevents ingress of environmental elements proximate the first end of the coupling member that is configured to mate with a port;
a compression portion structurally integral with the connector body, wherein the compression portion is configured to break apart from the body when axially compressed; and
an outer sleeve engageable with the coupling member, the sleeve configured to rotate the coupling member.
